(19) United States
(12) Patent Application Publication
(10) Pub. No.: US 2011/0304612 A1
(43) Pub. Date: Dec. 15, 2011

(54) Parallax system, parallax image panel, device having the parallax image panel, parallax display method and non-transitory computer readable medium

(75) Inventor: Tsuyoshi Ohyama, Tokyo (JP)

(73) Assignee: Sony Corporation, Tokyo (JP)

(21) Appl. No.: 13/067,432

(22) Filed: Jun. 1, 2011

(30) Foreign Application Priority Data
Jun. 10, 2010 (JP) 2010-132626

(51) Int. Cl. G06T 15/00

(52) U.S. Cl. 345/419

(57) ABSTRACT

A parallax system that includes a set of pixels disposed in a matrix where each pixel of the set of pixels has transmission portions and reflective portions symmetrically arranged about a pixel center. Further, the parallax system is implemented in a parallax image panel that may be embodied in one of a digital camera, a personal computer, a mobile terminal equipment, a video camera, or a game machine.

### BACKGROUND

The present disclosure relates to a stereoscopic image display device and an electronic apparatus, and more particularly to a stereoscopic image display device utilizing a binocular parallax, and an electronic apparatus having the same.

A depth can be sensed from a difference between images in retinas of a right eye and a left eye, that is, a binocular parallax, for example, a stereoscopic image display device utilizing the binocular parallax. According to the stereoscopic image display device utilizing the binocular parallax, an image displayed on a flat display device (flat display panel/flat panel) such as a liquid crystal display device can be sensed as an image in which an observer can sense the depth, that is, as a stereoscopic image (three-dimensional image/3D image).

In recent years, the development of a glasses-free stereoscopic image display device with which an observer (viewer) can sense the stereoscopic image by his/her naked eyes even if the observer does not wear dedicated glasses has advanced as the stereoscopic image display device utilizing the binocular parallax. Also, with regard to a system with which an image for the right eye, and an image for the left eye which are displayed on a display panel can be stereoscopically sensed, a parallax barrier system, a lenticular lens system, and the like are used for the glasses-free stereoscopic image display device.

The principles of the parallax barrier system will be described below as an example. It is noted that the parallax barrier system can be classified into a two parallax (two eyes) system, a multiple parallax (multiple eyes) system, and the like. In this case, the outline of the principles of the parallax barrier system will now be described with reference to FIG. 28 by giving the two parallax system as an example.

Firstly, in a matrix-like pixel arrangement in a display panel 51, pixels are classified into pixels R for a right eye in which an image for the right eye is displayed, and pixels L for a left eye in which an image for the left eye is displayed with a pixel column as a unit. Specifically, the pixels have a pixel arrangement in which a pixel column of the pixels R for the right eye, and a pixel column of the pixels L for the left eye are alternately arranged.

Also, a video signal for the right eye is supplied from a signal source 52_{R} to the pixels R for the right eye with the pixel column as the unit. A video signal for the left eye is supplied from a signal source 52_{L} to the pixels L for the left eye with the pixel column as the unit. As a result, the image for the right eye, and the image for the left eye can be displayed on a display panel 51. In this connection, the video signal from the signal source 52_{R}, and the video signal from the signal source 52_{L}, for example, can be created by carrying out the simultaneous photographing by using two cameras of a camera for the right eye, and a camera for the left eye, or by executing computer processing based on one video signal.

In addition, a parallax barrier 53 is disposed as an optical component for allowing the image for the right eye and the image for the left eye that are displayed on the display panel 51 to be stereoscopically sensed is disposed on the front side of the display panel 51. Also, the image for the right eye and the image for the left eye that are displayed on the display panel 51 are observed in a position located at a predetermined distance from the display panel 51 through the parallax barrier 53. As a result, lights from the pixels R for the right eye, and lights from the pixels L for the left eye are made incident as the image for the right eye, and the image for the left eye to the right eye and the left eye of the observer, respectively. As a result, the binocular parallax is generated, and thus the observer can sense the images displayed on the liquid crystal display panel 51 stereoscopically, that is, as the stereoscopic image.

Now, some of the stereoscopic image devices each utilizing the binocular parallax use a semi-transmission type liquid crystal display unit (liquid crystal panel) as the flat display unit (flat panel). Such a stereoscopic image display device, for example, is described in Japanese Patent Laid-Open No. 2005-316126. The semi-transmission type liquid crystal display device is a so-called liquid crystal display device having a reflection type liquid crystal display device and a transmission type liquid crystal display device merged with each other, in other words, having a reflection type structure and a transmission type structure mounted thereto. In this case, the semi-transmission type liquid crystal display device utilizes both an outside light and a backlight as a light source.

The semi-transmission type liquid crystal display device is excellent in visibility in any of a dark environment such as an indoor environment, and a light environment such as an outdoor environment. Therefore, the semi-transmission type liquid crystal display device is generally used as the flat display device for a mobile use application typified by a mobile phone or the like. Also, the semi-transmission type liquid crystal display device is structured to have a reflective portion and a transmissive portion within one pixel as a minimum unit composing a screen, or within plural sub-pixels composing one pixel in the case of the color display compliance. In this case, the reflective portion carries out the display with the outside light as the light source. Also, the transmissive portion carries out the display with the backlight as the light source.

FIG. 29 shows an outline of a structure of a stereoscopic image display device, according to the background art, using the semi-transmission type liquid crystal display device as the flat display device. In this case, the stereoscopic image display device is shown by exemplifying the case where the stereoscopic image display device, using the parallax barrier system, which uses the parallax barrier, for example, is used as an optical component for allowing an image for a right eye, and an image for a left eye which are displayed on a display panel to be stereoscopically sensed.

As shown in FIG. 29, the stereoscopic image display device 60 according to the background art is composed of a semi-transmission type liquid crystal panel 61, a parallax barrier 62, and a backlight 63. In this case, the parallax barrier 62 is disposed on a front surface of the semi-transmission type liquid crystal panel 61. Also, the backlight 63 is disposed on a back surface of the semi-transmission type liquid crystal panel 61.

The semi-transmission type liquid crystal panel 61 has two sheets of glass substrates 611 and 612, and a liquid crystal layer 613 that is sealed in an air-tight space defined between the two sheets of glass substrates 611 and 612. Also, for the purpose of realizing the display of a stereoscopic image, pixels R for a right eye, and pixels L for a left eye are alternately disposed with a pixel column as a unit in order to form an image for the right eye, and an image for the left eye.

FIG. 30 shows a cross sectional structure of a certain one pixel provided in the semi-transmission type liquid crystal panel 61. Also, FIG. 30 is a cross sectional view taken on line X-X′ of FIG. 31A. Referring now to FIG. 30, the pixel 70 has a transmissive portion 71 and a reflective portion 72. In this case, the transmissive portion 71 carries out the display by using an illuminated light from the backlight 63 with the backlight 63 as a light source. Also, the reflective portion 72 carries out the display by reflecting the outside light as a light source.

Specifically, an optical diffusion layer 615 in which an irregular diffusion surface is formed to correspond to the reflective portion 72 is provided on an inner surface of glass substrate 611 of the glass substrates 611 and 612 on which a pixel circuit including a pixel transistor 73 is formed through an insulating film 614. A pixel electrode 616 composed of a transparent electrode is provided on the optical diffusion layer 615 to correspond to the transmissive portion 71 with a pixel 70 as a unit. In addition, a reflective electrode 617 is provided on the irregular diffusion surface to correspond to the reflective portion 72.

A color filter (transmissive portion/reflective portion) 618 is provided on an inner surface of the other grass substrate 612 of the glass substrates 611 and 612. A transparent stepped layer 619 as a phase diffusion layer is provided in a portion, on the color filter 618 which corresponds to the reflective portion 72. In addition, a counter electrode 620 is provided on the color filter 618 and the transparent stepped layer 619 to be common to all the pixels 70. It is noted that a columnar spacer 621 for obtaining a constant thickness of the liquid crystal layer 613 formed between the reflective electrode 617 and the transparent stepped layer 619 is disposed in the reflective portion 72.

In the semi-transmission type liquid crystal panel 61 having the structure described above, a phase difference plate 64 and a polarizing plate 65 are provided in this order on a display back surface of the glass substrate 611, that is, on a surface of the backlight 63 side. A phase difference plate 66 and a polarizing plate 67 are provided in this order on a display surface as well of the glass substrate 612.

FIG. 31A shows an example of a structure of pixels 70 in the case of the color display compliance in the stereoscopic image display device 60 according to the background art. One pixel 70 as a minimum unit composing the screen, for example, is composed of three sub-pixels 70_{R}, 70_{G} and 70_{B} corresponding to Red (R), Green (G) and Blue (B), respectively. The pixel 70, for example, has a rectangular shape. In the rectangular pixel 70, the reflective portion 72 has a smaller area than that of the transmissive portion 71, and is formed along one side of a rectangle.

Referring back to FIG. 29, the parallax barrier 62, for example, adopts the liquid crystal system. Specifically, the parallax barrier 62 has two sheets of glass substrates 621 and 622, and a liquid crystal layer 623 that is sealed in an air-tight space defined between the two sheets of glass substrates 621 and 622. In one of the glass substrates 621 and 622, stripe-like electrodes are formed at given intervals along a column direction (vertical direction) of the pixel arrangement on the semi-transmission type liquid crystal panel 61. In the other of the glass substrates 621 and 622, a counter electrode is formed through the liquid crystal layer 623.

In the parallax barrier 62 using the liquid crystal system, when a suitable voltage is applied across the stripe-like electrodes and the counter electrode, stripe-like light blocking portions (barriers) are formed at given intervals to correspond to the stripe-like electrodes, respectively. Also, a portion between each adjacent two light blocking portions becomes a transmissive portion. As a result, the parallax barrier 62 using the liquid crystal system functions as an optical component for allowing an image displayed on the liquid crystal panel 61 to be stereoscopically sensed. In other words, the display of the three-dimensional image can be realized by applying a suitable voltage across the stripe-like electrodes and the counter electrode.

Contrary to this, when no suitable voltage is applied across the stripe-like electrodes and the counter electrode, the liquid crystal layer 623 becomes a transmission state (transmissive portion) throughout the entire surface. In this case, the parallax barrier 62 using the liquid crystal system does not have the function as the optical component for allowing the image for the right eye, and the image for the left eye which are displayed on the semi-transmission type liquid crystal panel 61 to be stereoscopically sensed. Therefore, when no suitable voltage is applied across the stripe-like electrodes and the counter electrode, the three-dimensional image is not displayed, but the normal two-dimensional image is displayed.

FIG. 31B shows a relatively positional relationship between the arrangement of the pixels R for the right eye, and the pixel L for the left eye in a certain pixel row, and a light blocking portion (barrier) 624 of the parallax barrier 62. Although a pitch of the parallax barrier 62 is approximately equal to that of a combination of the pixels R for the right eye, and the pixel L for the left eye, strictly, for causing the 3D image to be seen in anywhere within the panel between the eyes (an interval between the eyes, for example, is 65 mm), the pitch of the parallax barrier is designed to be slightly smaller than the pitch of the LR combination of the pixels 60. Also, the parallax barrier 62 is provided in such a way that the light blocking portion 624, for example, is located in a portion corresponding to the center of the pixel 70.

### SUMMARY

The present disclosure relates to a parallax system that comprises a set of pixels disposed in a matrix, wherein each pixel of the set of pixels has a transmission portion and a reflective portion, and the transmission portion and the reflective portion are symmetrically arranged about a pixel center.

Further, the transmission portion and the reflective portion may be symmetrically arranged in a row direction about the pixel center.

Furthermore, the transmission portion may be a set of two transmission portions that symmetrically boarder in the row direction the reflective portion that is centered on the pixel center. The reflective portion may be a set of two reflective portions that symmetrically boarder in the row direction the transmission portion that is centered on the pixel center.

Also, the transmission portions and the reflective portions may be alternatively arranged in parallel with a row direction of the pixel. The total area of the transmission portion may be greater than a total area of the reflective portion. A backlight may provide a luminance source for the transmission portion. An outside light may provide a luminance source for the reflective portion.

In addition, the parallax system may be a parallax barrier system that has a parallax barrier layer disposed on a side opposite a substrate side of the set of pixels disposed in matrix. The parallax barrier layer may comprise a set of blocking portions, wherein each blocking portion of the set of blocking portions corresponds to at least one pixel of the set of pixels.

The parallax system may also be a parallax lens system that has a parallax lens layer disposed on a side opposite a substrate side of the set of pixels disposed in matrix. The parallax lens layer may comprise of a set of parallax lenses, wherein each parallax lens of the set of parallax lenses corresponds to at least one pixel of the set of pixels.

Further, the described may be embodied in a parallax image panel and that parallax image panel may be in the device where the device may be one of a digital camera, a personal computer, a mobile terminal equipment, a video camera, or a game machine.

### BRIEF DESCRIPTION OF THE DRAWINGS

FIG. 1 is a cross sectional view showing an outline of a structure of a stereoscopic image display device;

FIGS. 2A and 2B are a view showing a structure of a pixel according to Example 1, and a view showing a relatively positional relationship between an arrangement of pixels for a right eye, and pixels for a left eye, and light blocking portions of a parallax barrier, respectively, in the case of color display compliance in the stereoscopic image display device;

FIG. 3 is a cross sectional view taken on line X-X′ of FIG. 2A, and showing a cross sectional view of the pixel structure according to Example 1;

FIG. 4 is a cross sectional view showing a relationship between a transmitted light and a reflected light for the right eye and the left eye in the case of the pixel structure according to Example 1;

FIGS. 5A and 5B are a view showing a structure of a pixel according to Example 2, and a view showing a relatively positional relationship between an arrangement of the pixels for the right eye, and the pixels for the left eye, and the light blocking portions of the parallax barrier, respectively, in the case of the color display compliance in the stereoscopic image display device;

FIG. 6 is a cross sectional view taken on line X-X′ of FIG. 5A, and showing a cross sectional view of the pixel structure according to Example 2;

FIG. 7 is a cross sectional view showing a relationship between the transmitted light and the reflected light for the right eye and the left eye in the case of the pixel structure of Example 2;

FIGS. 8A and 8B are a view showing a structure of a pixel according to Example 3, and a view showing a relatively positional relationship between an arrangement of the pixels for the right eye, and the pixels for the left eye, and the light blocking portions of the parallax barrier, respectively, in the case of the color display compliance in the stereoscopic image display device;

FIG. 9 is a cross sectional view taken on line X-X′of FIG. 8A, and showing a cross sectional view of the pixel structure according to Example 3;

FIG. 10 is a cross sectional view taken on line Y-Y′ of FIG. 8A, and showing a cross sectional view of the pixel structure according to Example 3;

FIG. 11 is a cross sectional view showing a relationship between the transmitted light and the reflected light for the right eye and the left eye in the case of the pixel structure of Example 3;

FIGS. 12A and 12B are a view showing a structure of a pixel according to Example 4, and a view showing a relatively positional relationship between an arrangement of the pixels for the right eye, and the pixels for the left eye, and the light blocking portions of the parallax barrier, respectively, in the case of the color display compliance in the stereoscopic image display device;

FIG. 13 is a cross sectional view taken on line Z-Z′ of FIG. 12A, and showing a cross sectional view of the pixel structure according to Example 4;

FIG. 14 is a cross sectional view showing a relationship between the transmitted light and the reflected light for the right eye and the left eye in the case of the pixel structure of Example 4;

FIGS. 15A, 15B and 15C are a view showing a structure of a pixel according to Example 5, a view showing a structure of the parallax barrier, and a view showing a relatively positional relationship between an arrangement of the pixels for the right eye, and the pixels for the left eye, and the light blocking portions of the parallax barrier, respectively, in the case of the color display compliance in the stereoscopic image;

FIG. 16 is a cross sectional view showing a relationship between the transmitted light and the reflected light for the right eye and the left eye in the case of the pixel structure of Example 5;

FIG. 17 is a cross sectional view showing an outline of a structure of a stereoscopic image display device;

FIGS. 18A and 18B are a view showing a structure of a pixel of a pixel according to Example 1, and a view showing a relatively positional relationship between an arrangement of the pixels for the right eye, and the pixels for the left eye, and a lenticular lens, respectively, in the case of the color display compliance in the stereoscopic image display device;

FIG. 19 is a cross sectional view showing a relationship between the transmitted light and the reflected light for the right eye and the left eye in the case of the pixel structure of Example 1;

FIG. 20 is a cross sectional view showing an outline of a structure of a stereoscopic image display device according to Example 2 using a liquid crystal lens as an optical component;

FIGS. 21A and 21B are a view showing a structure of a pixel according to Example 2, and a view showing a relatively positional relationship between an arrangement of the pixels for the right eye, and the pixels for the left eye, and the liquid crystal lens, respectively, in the case of the color display compliance in the stereoscopic image display device using a liquid crystal lens system;

FIG. 22 is a cross sectional view showing a relationship between the transmitted light and the reflected light for the right eye and the left eye in the case of the pixel structure of Example 2;

FIG. 23 is a perspective view of a television set as an example of application to which the stereoscopic image display device is applied;

FIGS. 24A and 24B are a perspective view of a digital camera as another example of application, when viewed from a front side, to which the stereoscopic image display device is applied, and a perspective view of the digital camera as another example of application, when viewed from a back side, to which the stereoscopic image display device is applied, respectively;

FIG. 25 is a perspective view showing a notebook-size personal computer as still another example of application to which the stereoscopic image display device of the embodiment of the present disclosure is applied;

FIG. 26 is a perspective view showing a video camera, as yet another example of application, to which the stereoscopic image display device is applied;

FIGS. 27A to 27G are a front view of mobile terminal equipment, for example, a mobile phone as a further example of application, in an open state, to which the stereoscopic image display device is applied, a side elevational view thereof in the open state, a front view thereof in a close state, a left side elevational view thereof in the close state, a right side elevational view thereof in the close state, a top plan view thereof, and a bottom view thereof in the close state, respectively;

FIG. 28 is a view explaining an outline of the principles of the parallax barrier system;

FIG. 29 is a cross sectional view showing an outline of a structure of a stereoscopic image display device, according to the background art, using a semi-transmission type liquid crystal display unit as a flat display unit;

FIG. 30 is a cross sectional view showing a cross sectional structure of certain one pixel in a semi-transmission type liquid crystal panel according to the background art;

FIGS. 31A and 31B are a view of a structure of a pixel, and a view showing a relatively positional relationship between an arrangement of pixels for a right eye, and pixels for a left eye in a certain pixel row, and a light blocking portion of a parallax barrier in the case of color display compliance in the stereoscopic image display device according to the background art; and

FIG. 32 is a cross sectional view explaining a problem of the background art.

### DETAILED DESCRIPTION OF THE PREFERRED EMBODIMENTS

As described above, the pixel 70 according to the background art has a structure such that the reflective portion 72 is provided to be biased to one side of the pixel 70, that is, the reflective portion 72 is provided so as to be biased with respect to the transmissive portion 71. Therefore, when the parallax barrier 62 is provided in such a way that the light blocking portion 624 is located in the portion corresponding to the center of the pixel 70, the transmissive portion 71 and the reflective portion 72 of the pixel 70 are disposed unsymmetrically with respect to the central position of the transmissive portion 625 of the parallax barrier 62.

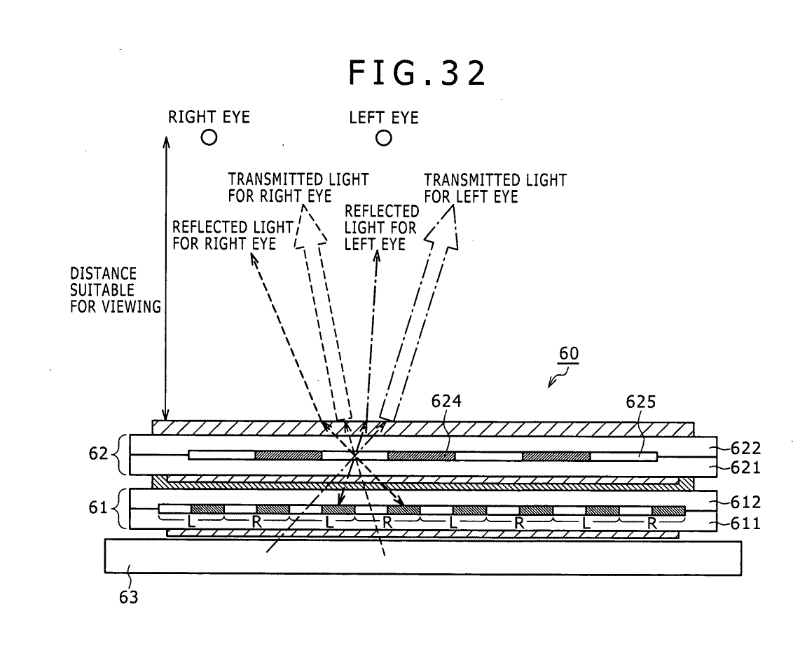

As a result, a position of a viewpoint of the observer is shifted between the transmissive portion 71 and the reflective portion 72, and thus the transmissive portion 71 and the reflective portion 72 are disposed unsymmetrically with respect to the position of the viewpoint. For example, if the central position of the light blocking portion 624 of the parallax barrier 62 is made to agree with the central position of the pixel 70, when as shown in FIG. 32, the observation is carried out in front of those central positions, both the transmissive portion 71 and the reflective portion 72 are not optimally disposed for the observation position.

Specifically, luminance information transmitted through the transmissive portion 71 of the pixel R for the right eye and luminance information reflected by the reflective portion 72 of the pixel R for the right eye, and luminance information transmitted through the transmissive portion 71 of the pixel L for the left eye and luminance information reflected by the reflective portion 72 of the pixel L for the left eye are not equally made incident to the right eye and the left eye of the observer, and thus become right-left asymmetrical. As a result, the luminance information for the left eye is mixed with the luminance information for the right eye to be made incident to the left eye, a so-called crosstalk is generated. Since the generation of the crosstalk disturbs the stereoscopic sensing, the generation of the crosstalk causes the visibility to become worse.

In view of the above, it is desirable to provide a stereoscopic image display device in which when a semi-transmission type liquid crystal display device is used, luminance information for a right eye and luminance information for a left eye can be made to be equally sensed, thereby enhancing visibility of a stereoscopic image, and an electronic apparatus having the same.

As set forth hereinabove, accordingly, since in the stereoscopic image display device using the semi-transmission type image display portion, the luminance information for the right eye, and the luminance information for the left eye can be equally sensed by the right eye and left eye of the observer, it is possible to enhance the visibility of the stereoscopic image.

The preferred embodiments will be described in detail hereinafter with reference to the accompanying drawings. It is noted that the description will be given below in accordance with the following order.

### 1. First Embodiment (Parallax Barrier System)

1-1. Example 1

1-2. Example 2

1-3. Example 3

1-4. Example 4

1-5. Example 5

### 2. Second Embodiment (Lenticular Lens System)

2-1. Example 1

2-2. Example 2

### 3. Changes

### 4. Third Embodiment (Electronic Apparatus)

4-1. Examples of Application

### 1. First Embodiment

### Parallax Barrier System

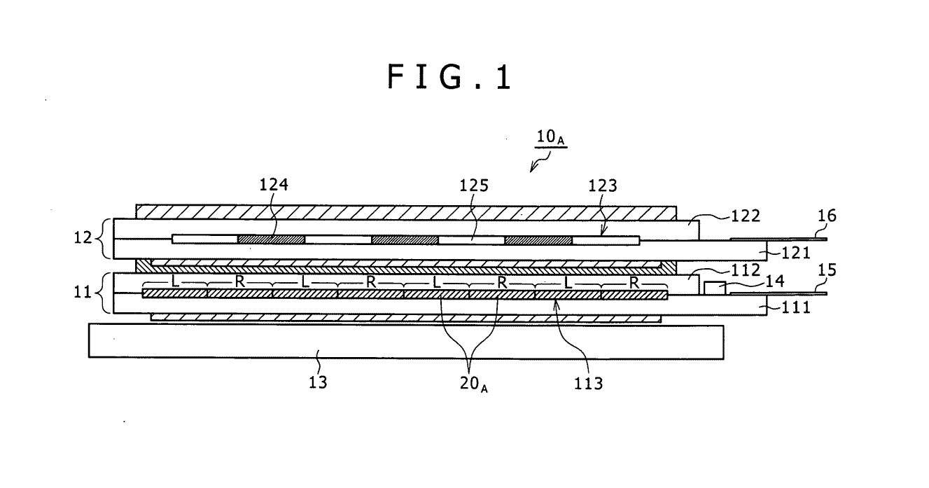

FIG. 1 is a cross sectional view showing an outline of a structure of a stereoscopic image display device according to a first embodiment. The stereoscopic image display device according to the first embodiment is a stereoscopic image display device, using a parallax barrier system, which uses a parallax barrier as an optical component for allowing plural parallax images displayed by a display panel to be stereoscopically sensed.

As shown in FIG. 1, the stereoscopic image display device 10_{A} according to the first embodiment of the present disclosure, for example, uses a semi-transmission type liquid crystal panel 11 as a semi-transmission type display portion. Also, the stereoscopic image display device 10_{A} is structured so as to have a parallax barrier 12 and a backlight 13. In this case, the parallax barrier 12 is disposed on a front surface (on an observer side) of the semi-transmission type liquid crystal panel 11. Also, the backlight 13 is disposed on a back surface of the transmission type liquid crystal panel 11.

The transmission type liquid crystal panel 11 has two sheets of transparent substrates (hereinafter referred to as “glass substrates”) 111 and 112 such as glass substrates, and a liquid crystal layer 113 which is sealed in an air-tight space defined between these glass substrates 111 and 112. As will be described later, pixel electrodes and a counter electrode are formed on inner surfaces of the glass substrates 111 and 112, respectively, to sandwich the liquid crystal layer 113 between them. The counter electrode is formed to be common to all the pixels. On the other hand, the pixel electrodes are formed in pixels. Also, for the purpose of realizing the display of the stereoscopic image, pixels R for a right eye, and pixels L for a left eye are alternately disposed to form an image for the right eye, and an image for the left eye.

A semiconductor chip 14 in which a driving portion for driving the liquid crystal panel 11 is integrated is mounted on one 111 of the glass substrates 111 and 112 by, for example, utilizing a Chip On Glass (COG) technique. The semiconductor chip 14 is electrically connected to a control system provided outside the glass substrate 111 through a Flexible Printed Circuits (FPC) substrate 15.

The parallax barrier 12, for example, adopts a liquid crystal system. Specifically, the parallax barrier 12 has two sheets of transparent substrates (hereinafter referred to as “glass substrates”) 121 and 122 such as glass substrates, and a liquid crystal layer 123 that is sealed in an air-tight space defined between these glass substrates 121 and 122.

Stripe-like electrodes are formed at given intervals along a column direction (along a vertical direction) of the semi-transmission type liquid crystal panel 11 on one of the glass substrate 121 and 122. A counter electrode is formed on the other of the glass substrate 121 and 122 through the liquid crystal layer 123. In addition, a flexible printed circuits substrate 16 for fetching in a suitable voltage intended to be applied across the stripe-like electrodes and the counter electrode from the outside of the glass substrate 121 is provided in the glass substrate 121.

In the parallax barrier 12 using the liquid crystal system, when the suitable voltage is applied across the stripe-like electrodes and the counter electrode, stripe-like light blocking portions (barriers) are formed at given intervals to correspond to the stripe-like electrodes, respectively. Also, a portion between each adjacent two light blocking portions becomes a transmissive portion. As a result, the parallax barrier 12 using the liquid crystal system has a function as an optical component for allowing an image displayed on the liquid crystal panel 11 to be stereoscopically sensed. In other words, the display of a three-dimensional image can be realized by applying the suitable voltage across the stripe-like electrodes and the counter electrode.

Contrary to this, when no suitable voltage is applied across the stripe-like electrodes and the counter electrode, the liquid crystal layer 123 becomes a transmission state throughout the entire surface. In this case, the parallax barrier using the liquid crystal system does not have the function as the optical component for allowing the image for the right eye, and the image for the left eye which are displayed on the semi-transmission type liquid crystal panel 11 to be stereoscopically sensed. Therefore, when no suitable voltage is applied across the stripe-like electrodes and the counter electrode, the three-dimensional image is not displayed, but the normal two-dimensional image is displayed on the semi-transmission type liquid crystal panel 11.

In the stereoscopic image display device 10_{A}, using the parallax barrier system, which has the structure described above, since the liquid crystal panel 11 is a semi-transmission type liquid crystal panel, a pixel (sub-pixel) 20 has a transmissive portion and a reflective portion. In this case, the transmissive portion carries out the display by using an illuminated light from the backlight 13. Also, the reflective portion carries the display by reflecting the outside light. Also, in the first embodiment, a structure is adopted such that the transmissive portion and reflective portion of the pixel 20 are provided symmetrically in a row direction (that is, in a horizontal direction) with respect to a pixel center, that is, right-left symmetrically with respect to a position for visual recognition made by an observer (viewer).

In the stereoscopic image display device, an image for a right eye is displayed by the pixels R for the right eye and an image for a left eye is displayed by the pixels L for the left eye. Therefore, the transmissive portion and the reflective portion of each of the pixels 20 are provided right-left symmetrically with respect to the center of the corresponding one of the pixels 20. As a result, luminance information transmitted through the transmissive portion of the pixel R for the right eye and luminance information reflected by the reflective portion of the pixel R for the right eye, and luminance information transmitted through the transmissive portion of the pixel L for the left eye and luminance information reflected by the reflective portion of the pixel L for the left eye are equally made incident to both the right eye and left eye of the observer, respectively. That is to say, the luminance information for the right eye, and the luminance information for the left eye which are made incident to the right eye and left eye of the observer, respectively, become equal with respect to the right eye and left eye of the observer. As a result, since the observer can equally sense the luminance information for the right eye, and the luminance information for the left eye by his/her both eyes, visibility of the stereoscopic image is enhanced.

Hereinafter, a description will be given with respect to concrete Examples in each of which the transmissive portion and the reflective portion of the pixel 20 are provided right-left symmetrically with respect to the pixel center, that is, right-left symmetrically with respect to the positions for the visual recognition made by the observer in the stereoscopic image display device 10_{A} using the parallax system according to the first embodiment.

### 1-1. Example 1

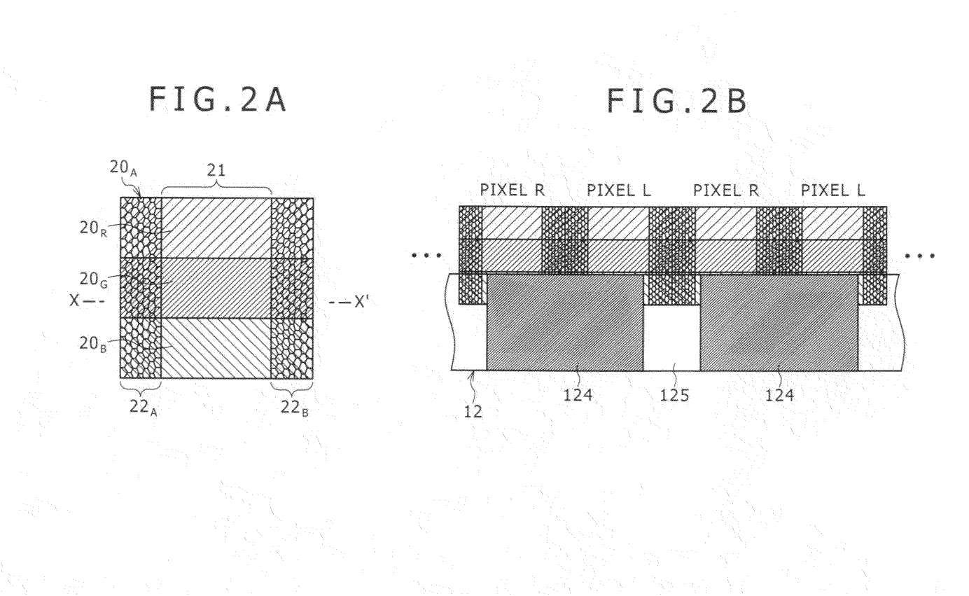

FIGS. 2A and 2B are a view showing a structure of a pixel of according to Example 1, and a view showing a relatively positional relationship between an arrangement of the pixels for the right eye, and the pixels for the left eye, and the light blocking portions of the parallax barrier, respectively, in the case of the color display compliance in the stereoscopic image display device 10_{A} according to the first embodiment.

As shown in FIG. 2A, the pixel 20_{A}, according to Example 1, as a minimum unit composing the screen, for example, is composed of sub-pixels 20_{R}, 20_{G} and 20_{B} corresponding to the three primary colors of Red (R), Green (G) and Blue (B), respectively. The pixel 20_{A}, for example, has a rectangular shape. Therefore, each of the three sub-pixels 20_{R}, 20_{G} and 20_{B} has a rectangular shape which is long in the row direction of the matrix-like pixel arrangement.

Also, the pixel 20_{A} according to Example 1 has a transmissive portion 21 and a reflective portions 22_{A} and 22_{B} every the sub-pixels 20_{R}, 20_{G} and 20_{B}. In this case, the transmissive portion 21 carries out the display by using the illuminated light from the backlight 13. Also, the reflective portions 22_{A} and 22_{B} carry out the display by reflecting the outside light. In the pixel 20_{A} having the rectangular shape, each of the reflective portions 22_{A} and 22_{B}, for example, have a smaller area than that of the transmissive portion 21 in terms of a total area. Also, the reflective portions 22_{A} and 22_{B} are formed right-left symmetrically along two sides of the rectangle so as to sandwich the transmissive portion 21 between them.

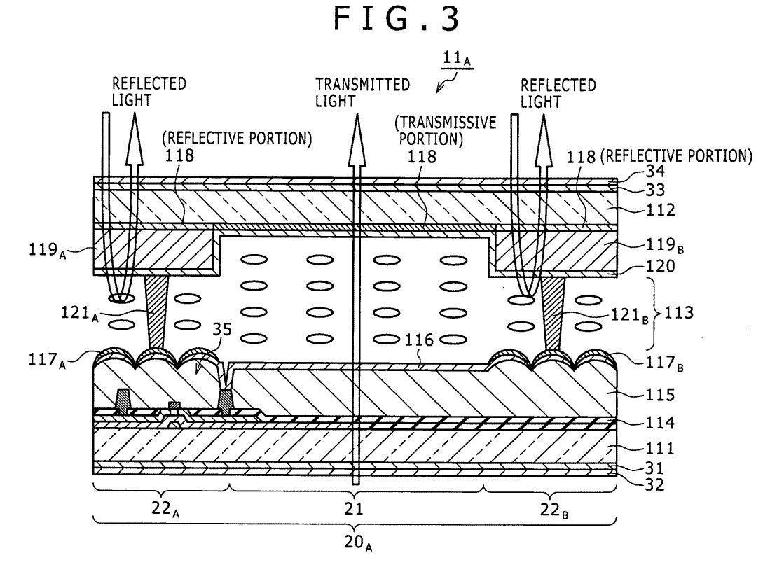

FIG. 3 shows a cross sectional structure of certain one pixel in a semi-transmission type liquid crystal panel 11_{A} according to Example 1. Also, FIG. 3 is a cross sectional view taken on line X-X′ of FIG. 2A. Referring to FIG. 3, the pixel 20_{A} has the transmissive portion 21 and the reflective portions 22_{A} and 22_{B}. In this case, the transmissive portion 21 carries out the display by using the illuminated light from the backlight 13 with the backlight 13 as the light source. Also, the reflective portions 22_{A} and 22_{B} carry out the display by reflecting the outside light with the outside light as the light source. As described above, in the pixel 20_{A}, the reflective portions 22_{A} and 22_{B} are provided right-left symmetrically with the transmissive portion 21 as the center so as to sandwich the transmissive portion 21 between them.

The structure of the pixel 20_{A} will now be concretely described. An optical diffusion layer 115 is provided on an inner surface of one 111 of the glass substrates 111 and 112 on which the pixel circuit including the pixel transistor 35 and the like is formed through an insulating film 114. In this case, irregular diffusion surfaces are formed on both end portions of the optical diffusion layer 115 so as to correspond to the reflective portions 22_{A} and 22_{B}, respectively. A pixel electrode 116 composed of a transparent electrode is provided in pixels on the optical diffusion layer 115 so as to correspond to the transmissive portion 21 at a center portion. In addition, reflective electrodes 117_{A} and 117_{B} are provided on the irregular diffusion surfaces so as to correspond to the reflective portions 22_{A} and 22_{B} in the both end portions, respectively.

A color filter (having a transmissive portion and a reflective portion) 118 is provided on an inner surface of the other 112 of the glass substrates 111 and 112. In addition, transparent stepped layers 119_{A} and 119_{B} are provided in portions corresponding to the reflective portions 22_{A} and 22_{B} in the both end portions, respectively. Moreover, a counter electrode 120 is provided on the color filter 118, and the transparent stepped layers 119_{A} and 119_{B} so as to be common to all the pixels 20_{A}. It is noted that columnar spacers 121_{A} and 121_{B} for obtaining a constant thickness of the liquid crystal layer 113 between the reflective electrode 117_{A} and the transparent stepped layer 119_{A}, and the reflective electrode 117_{B} and the transparent stepped layer 119_{B} are disposed in the reflective portions 22_{A} and 22_{B}, respectively. In addition, although not illustrated, alignment films for aligning the liquid crystal are formed on the uppermost surfaces of the glass substrates 111 and 112, respectively.

In the semi-transmission type liquid crystal panel 11_{A} according to Example 1 having the structure described above, a phase difference plate 31 and a polarizing plate 32 are provided in this order on the display back surface of the glass substrate 111, that is, on the surface on the backlight 13 side. A phase difference plate 33 and a polarizing plate 34 are provided in this order on the display surface as well of the glass substrate 112.

As previously stated, in the parallax barrier 12 using the liquid crystal system, when the suitable voltage is applied across the stripe-like electrodes and the counter electrode, as shown in FIG. 2B, the stripe-like light blocking portions 124 are formed at the given intervals so as to correspond to the stripe-like electrodes, respectively. Also, the portion between each adjacent two light blocking portions 124, 124 becomes the transmissive portion 125.

FIG. 2B shows the relatively positional relationship between the arrangement of the pixels R for the right eye and the pixels L for the left eye in a certain pixel row, and the light blocking portion (barrier) 124 of the parallax barrier 12. As apparent from FIG. 2B, although a pitch of the parallax barrier 12 is approximately equal to that of a combination of the pixels R for the right eye and the pixel L for the left eye, strictly, for causing the 3D image to be seen in anywhere within the panel between the eyes (the interval between the eyes, for example, is 65 mm), the pitch of the parallax barrier is designed so as to be slightly smaller than that of the RL combination of the pixels R and L. Also, the parallax barrier 12 is provided in such a way that the light blocking portion 124 is located in a portion corresponding to the center of the pixel 20_{A}, that is, the center of the transmissive portion 21 of the pixel 20_{A} in Example 1, and the transmissive portion 125 is located in a portion corresponding to a portion between the pixels 20_{A}, 20_{A}.

As described above, in Example 1, the pixel structure is adopted such that in the pixel 20_{A}, the transmissive portion 21 is provided at the central portion in a direction orthogonal to the arrangement direction of the sub-pixels 20_{R}, 20_{G} and 20_{B}, that is, in the row direction, and the reflective portions 22_{A} and 22_{B} are provided right-left symmetrically on the both sides of the pixel 20_{A} so as to sandwich the transmissive portion 21 between them (refer to FIG. 2A). That is to say, the transmissive portion 21, and the reflective portions 22_{A} and 22_{B} are provided right-left symmetrically with respect to the pixel center within the pixel 20_{A}. Also, the parallax barrier 12 is provided in such a way that the light shielding portion 124 is located in the portion corresponding to the center of the pixel 20_{A}, and the transmissive portion 125 is located in the portion corresponding to the portion between the pixels 20_{A}, 20_{A} (refer to FIG. 2B).

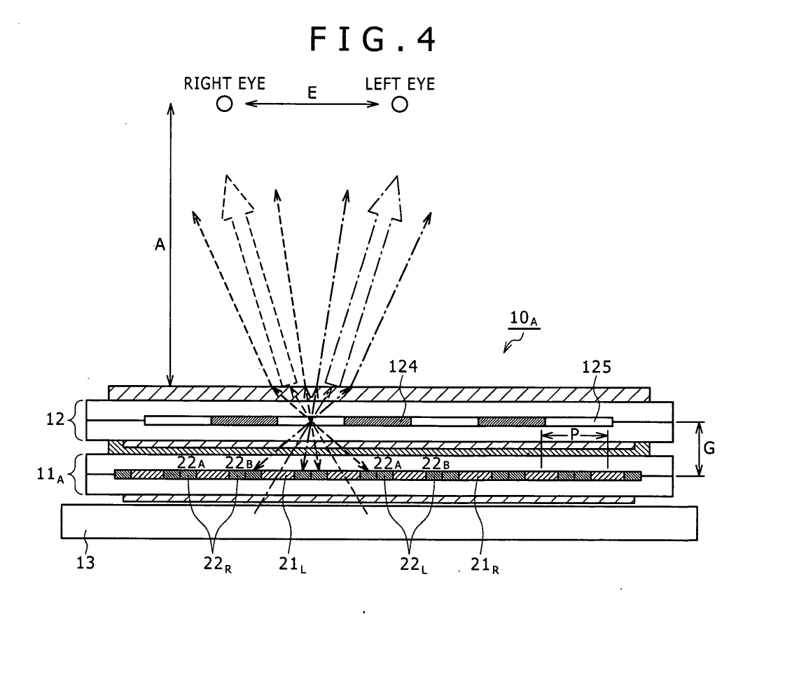

According to the pixel structure, and the relatively positional relationship between the pixel 20_{A} and the light blocking portion 124 of the parallax barrier 12 in such Example 1, as shown in FIG. 4, the transmissive portion 21, and the reflective portions 22_{A} and 22_{B} of the pixel 20_{A} are provided right-left symmetrically in the row direction with respect to the positions for the visual recognition made by the observer. It is noted that the positions of both the eyes of the observer become the positions for the visual recognition made by the observer. This also applies to the following description.

As a result, the luminance information transmitted through the transmissive portion 21_{R} of the pixel R for the right eye and the luminance information reflected by the reflective portions 22_{R} (22_{A} and 22_{B}) of the pixel R for the right eye, and luminance information transmitted through the transmissive portion 21_{L} of the pixel L for the left eye and the luminance information reflected by the reflective portions 22_{L} (22_{A} and 22_{B}) of the pixel L for the left eye are equally made incident to both the right eye and left eye of the observer. That is to say, since the luminance information for the right eye, and the luminance information for the left eye which are made incident to the right eye and left eye of the observer, respectively, become equal to each other with respect to the right eye and left eye of the observer, it is possible to suppress the crosstalk. As a result, since the observer can equally sense the luminance information for the right eye, and the luminance information for the left eye by his/her eyes, it is possible to enhance the visibility of the stereoscopic image.

Here, the positions for the visual recognition made by the observer mean an optimal viewing distance from the display surface of the stereoscopic image display device 10_{A}, that is, the positions of both the eyes of the observer (viewer) in a position A suitable for the viewing in FIG. 4. An interval E of the both eyes of the human being generally falls within the range of about 60 to about 65 mm. Here, the position A suitable for the viewing is approximately given by Expression (1):

A=(E·G/n)/P (1)

where G is a gap between the centers of the semi-transmission type liquid crystal panel 11_{A} and the parallax barrier 12 in a thickness direction, P is a pitch between the pixels, and n (≈1.5) is a refractive index of the transparent substrate such as a glass substrate.

### 1-2. Example 2

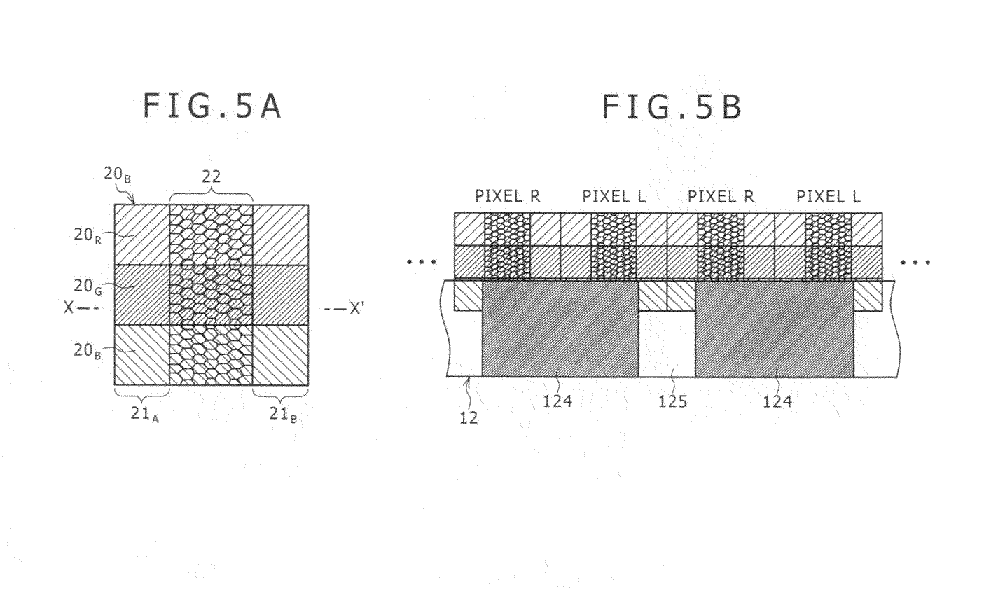

FIGS. 5A and 5B are a view showing a structure of a pixel according to Example 2, and a view showing a relatively positional relationship between an arrangement of the pixels R for the right eye, and the pixels L for the left eye, and the light blocking portions of the parallax barrier, respectively, in the case of the color display compliance in the stereoscopic image display device 10_{A} according to the first embodiment. In FIGS. 5A and 5B, the same portions as those in FIGS. 2A and 2B are designated by the same reference numerals or symbols, respectively.

As shown in FIG. 5A, a pixel 20_{B} according to Example 2 is also composed of, for example, the three sub-pixels 20_{R}, 20_{G} and 20_{B} similarly to the case of the pixel 20_{A} according to Example 1, and, for example, has the rectangular shape. Therefore, each of the three sub-pixels 20_{R}, 20_{G} and 20_{B} has the rectangular shape which is long in the row direction of the matrix-like pixel arrangement.

Also, the pixel 20_{B} according to Example 2 has a transmissive portions 21_{A} and 21_{B}, and a reflective portion 22 every the sub-pixels 20_{R}, 20_{G} and 20_{B}. In this case, the transmissive portions 21_{A} and 21_{B} carry out the display by using the illuminated light from the backlight 13. Also, the reflective portion 22 carries out the display by reflecting the outside light. In the pixel 20_{B} having the rectangular shape, the transmissive portions 21_{A} and 21_{B}, for example, have a larger area than that of the reflective portion 22 in terms of the total area, and are formed right-left symmetrically along the two sides of the rectangle so as to sandwich the reflective portion 22 between them.

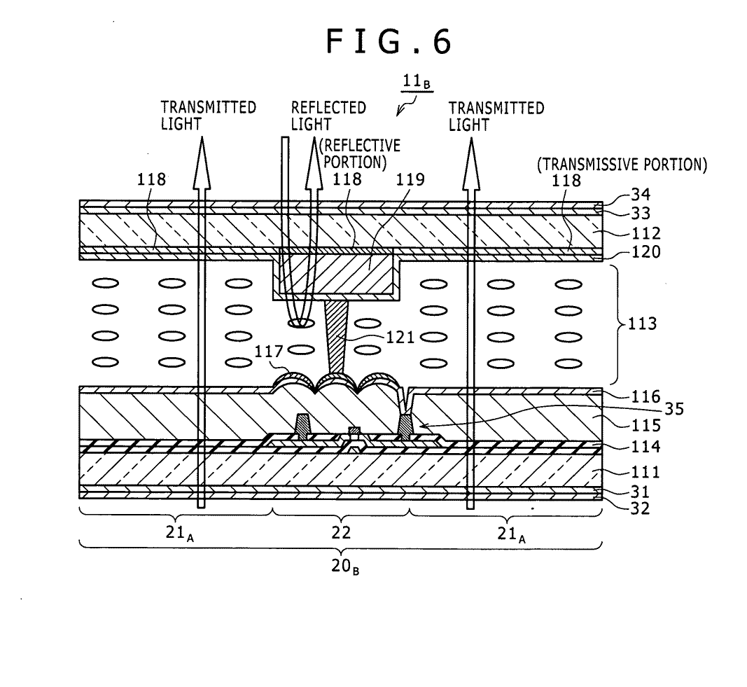

FIG. 6 shows a cross sectional structure of certain one pixel 20_{B} in a semi-transmission type liquid crystal panel 11_{B} according to Example 2. Also, FIG. 6 is a cross sectional view taken on line X-X′ of FIG. 5A. Referring to FIG. 6, the pixel 20_{B} has transmissive portions 21_{A} and 21_{B}, and a reflective portion 22. In this case, the transmissive portions 21_{A} and 21_{B} carry out the display by using the illuminated light from the backlight 13 with the backlight 13 as the light source. Also, the reflective portion 22 carries out the display by reflecting the outside light with the outside light as the light source. As described above, in the pixel 20_{B}, the transmissive portions 21_{A} and 21_{B} are provided right-left symmetrically with the reflective portion 22 as the center so as to sandwich the reflective portion 22 between them.

The structure of the pixel 20_{B} will now be concretely described. The optical diffusion layer 115 is provided on the inner surface of one 111 of the glass substrates 111 and 112 on which the pixel circuit including the pixel transistor 35 and the like is formed through the insulating film 114. In this case, an irregular diffusion surface is formed at the central portion of the optical diffusion layer 115 so as to correspond to the reflective portion 22. The pixel electrodes 116 each composed of the transparent electrode are provided in pixels on the optical diffusion layer 115 so as to correspond to the transmissive portions 21_{A} and 21_{B} in the both end portions, respectively. In addition, a reflective electrode 117 is provided on the irregular diffusion surface so as to correspond to the reflective portion 22 at the central portion.

The color filter (having the transmissive portion and the reflective portion) 118 is provided on the inner surface of the other 112 of the glass substrates 111 and 112. In addition, a transparent stepped layer 119 is provided in a portion corresponding to the reflective portion 22 at the central portion. Moreover, the counter electrode 120 is provided on the color filter 118 and the transparent stepped layer 119 so as to be common to all the pixels 20_{B}. It is noted that a columnar spacer 121 for obtaining a constant thickness of the liquid crystal layer 113 formed between the reflective electrode 117 and the transparent stepped layer 119 is disposed in the reflective portion 22.

In the semi-transmission type liquid crystal panel 11_{B} according to Example 2 having the structure described above, the phase difference plate 31 and the polarizing plate 32 are provided in this order on the display back surface of the glass substrate 111, that is, on the surface on the backlight 13 side. The phase difference plate 33 and the polarizing plate 34 are provided in this order on the display surface as well of the glass substrate 112.

As also previously stated, in the parallax barrier 12 using the liquid crystal system, when the suitable voltage is applied across the stripe-like electrodes and the counter electrode, as shown in FIG. 5B, the stripe-like light blocking portions 124 are formed at the given intervals so as to correspond to the stripe-like electrodes, respectively. Also, the portion between each adjacent two light blocking portions 124, 124 becomes the transmissive portion 125.

FIG. 5B shows the relatively positional relationship between the arrangement of the pixels R for the right eye and the pixels L for the left eye in a certain pixel row, and the light blocking portion (barrier) 124 of the parallax barrier 12. As can be seen from FIG. 5B, the light blocking portions 124 of the parallax barrier 12 are formed at the same interval as the pixel pitch in the row direction (in the horizontal direction) of the pixel arrangement. Also, the parallax barrier 12 is provided in such a way that the light blocking portion 124 is located in a portion corresponding to the center of the pixel 20_{B}, that is, the center of the reflective portion 22 of the pixel 20_{B} in Example 2, and the transmissive portion 125 is located in the portion corresponding to the portion between the pixels 20_{B}, 20_{B}.

As described above, in Example 2, the pixel structure is adopted such that in the pixel 20_{B}, the reflective portion 22 is provided at the central portion in the direction orthogonal to the arrangement direction of the sub-pixels 20_{R}, 20_{G} and 20_{B}, that is, in the row direction, and the transmissive portions 21_{A} and 21_{B} are provided right-left symmetrically on the both sides of the pixel 20_{B} so as to sandwich the reflective portion 22 between them (refer to FIG. 5A). That is to say, the transmissive portions 21_{A} and 21_{B}, and the reflective portion 22 are provided right-left symmetrically with respect to the pixel center within the pixel 20_{B}. Also, the parallax barrier 12 is provided in such a way that the light blocking portion 124 is located in the portion corresponding to the center of the pixel 20_{B}, and the transmissive portion 125 is located in the portion corresponding to the portion between the pixels 20_{B}, 20_{B} (refer to FIG. 5B).

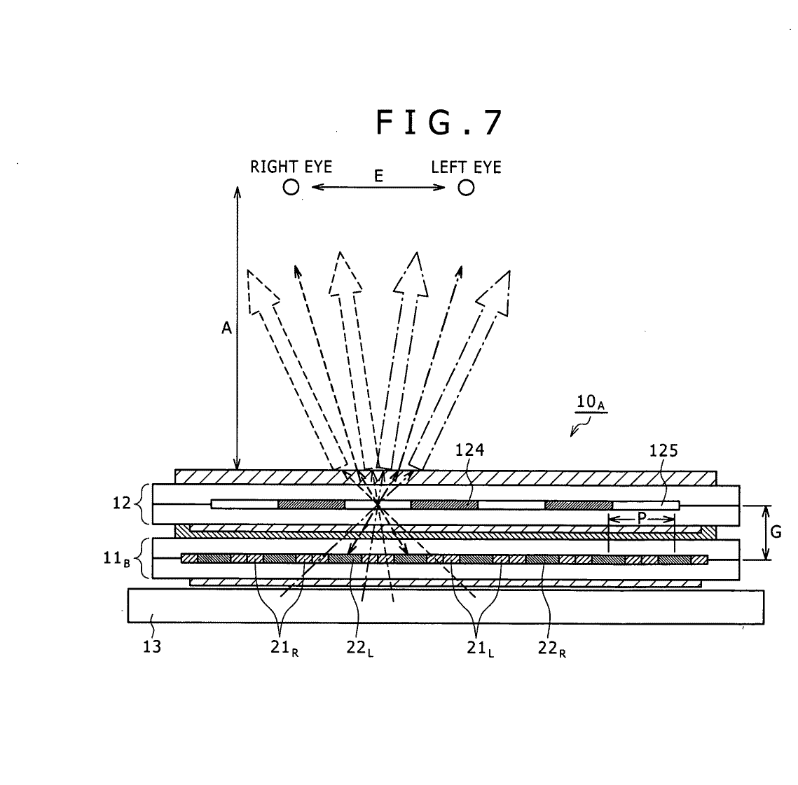

According to the pixel structure, and the relatively positional relationship between the pixel 20_{B} and the light blocking portion 124 of the parallax barrier 12 in such Example 2, as shown in FIG. 7, the transmissive portions 21_{A} and 21_{B}, and the reflective portion 22 of the pixel 20_{B} are provided right-left symmetrically in the row direction with respect to the positions for the visual recognition made by the observer.

As a result, the luminance information transmitted through the transmissive portions 21_{R} (21_{A}, 21_{B}) of the pixel R for the right eye, and the luminance information reflected by the reflective portion 22_{R} of the pixel R for the right eye, and the luminance information transmitted through the transmissive portion 21_{L} (21_{A}, 21_{B}) of the pixel L for the left eye, and the luminance information reflected by the reflective portion 22_{L} of the pixel L for the left eye are equally made incident to both the right eye and left eye of the observer. That is to say, since the luminance information for the right eye, and the luminance information for the left eye which are made incident to the right eye and left eye of the observer, respectively, become equal to each other with respect to the right eye and left eye of the observer, it is possible to suppress the crosstalk. As a result, since the observer can equally sense the luminance information for the right eye, and the luminance information for the left eye by his/her both eyes, it is possible to enhance the visibility of the stereoscopic image. The positions for the visual recognition made by the observer are the same as those in the case of Example 1.

### 1-3. Example 3

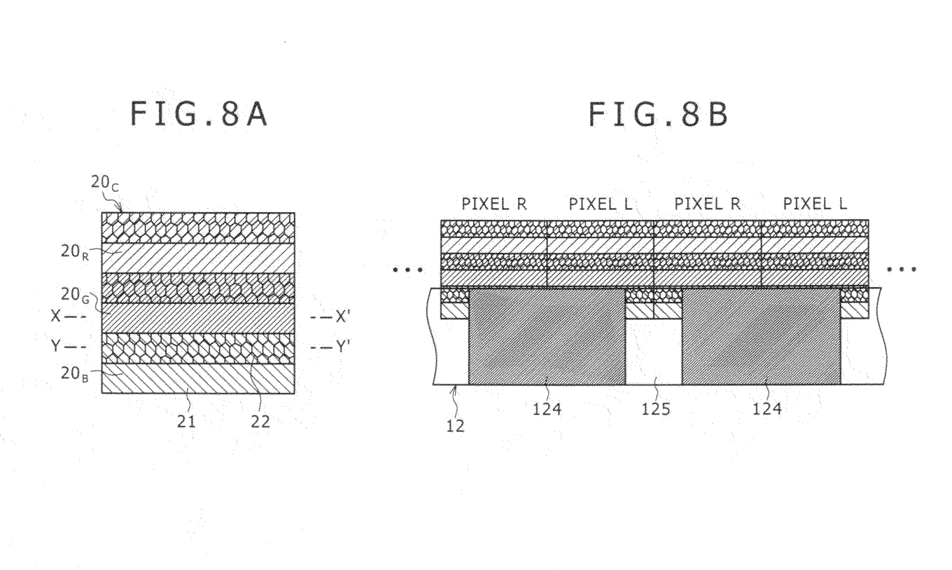

FIGS. 8A and 8B are a view showing a structure of a pixel 20_{C} according to Example 3, and a view showing a relatively positional relationship between an arrangement of the pixels R for the right eye, and the pixels L for the left eye, and the light blocking portions of the parallax barrier, respectively, in the case of the color display compliance in the stereoscopic image display device 10_{A} according to the first embodiment. In FIGS. 8A and 8B, the same portions as those in FIGS. 2A and 2B are designated by the same reference numerals or symbols, respectively.

As shown in FIG. 8A, the pixel 20_{C} according to Example 3 is also composed of, for example, the three sub-pixels 20_{R}, 20_{G} and 20_{B} similarly to the case of the pixel 20_{A} according to Example 1, and, for example, has the rectangular shape. Therefore, each of the three sub-pixels 20_{R}, 20_{G} and 20_{B} has the rectangular shape which is long in the row direction of the matrix-like pixel arrangement.

Also, in the pixel 20_{C} according to Example 3, a transmissive portion 21 and a reflective portion 22 are provided in parallel with each other every the sub-pixels 20_{R}, 20_{G} and 20_{B}. In this case, the transmissive portion 21 carries out the display by using the illuminated light from the backlight 13. Also, the reflective portion 22 carries out the display by reflecting the outside light. Specifically, the transmissive portion 21 and the reflective portion 22 are formed in parallel with each other along a direction orthogonal to the arrangement direction of the sub-pixels 20_{R}, 20_{G} and 20_{B}, that is, along the row direction of the matrix-like pixel arrangement every the sub-pixels 20_{R}, 20_{G} and 20_{B}. The row direction of the matrix-like pixel arrangement is a long side direction of each of the sub-pixels 20_{R}, 20_{G} and 20_{B}. Therefore, the transmissive portion 21 and the reflective portion 22 are disposed in parallel with the long side direction of each of the sub-pixels 20_{R}, 20_{G} and 20_{B}.

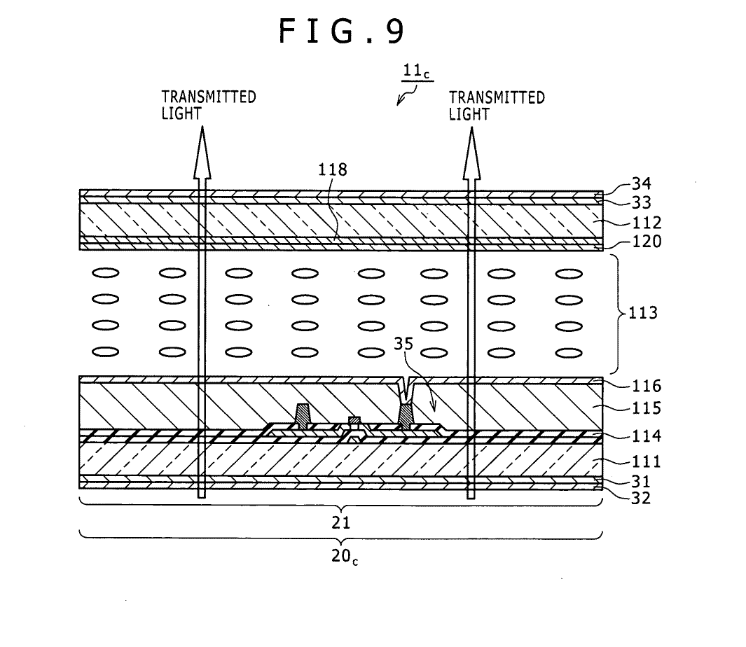

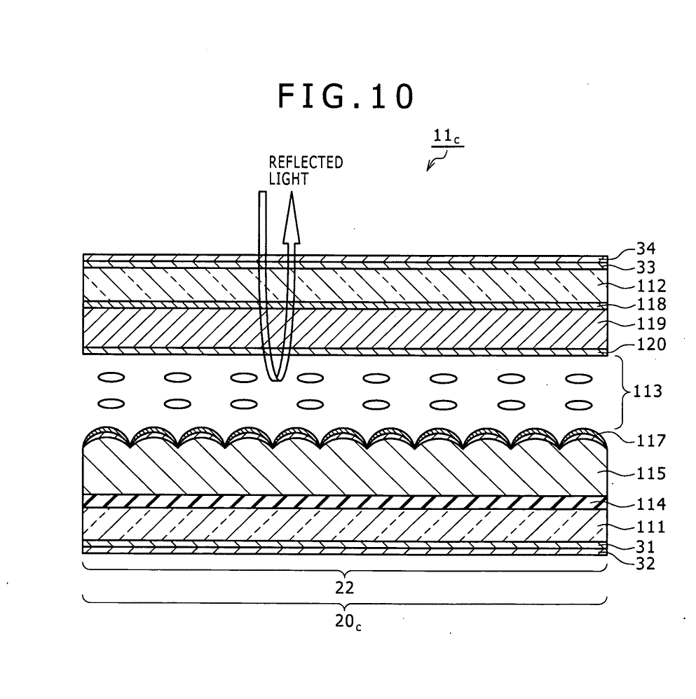

FIGS. 9 and 10 show respective cross sectional structures of certain one pixel 20_{C} in the semi-transmission type liquid crystal panel 11_{C} according to Example 3. Here, FIG. 9 is a cross sectional view taken on line X-X′ of FIG. 8A, and showing a cross sectional structure of the transmissive portion 21. Also, FIG. 10 is a cross sectional view taken on line Y-Y′ of FIG. 8A, and showing a cross sectional structure of the reflective portion 22.

In FIG. 9 showing the cross sectional structure of the transmissive portion 21, the optical diffusion layer 115 is provided on the inner surface of one 111 of the glass substrates 111 and 112 on which the pixel circuit including the pixel transistor 35 and the like is formed through the insulating film 114. The pixel electrode 116 composed of the transparent electrode is formed in pixels on the optical diffusion layer 115. The color filter (transmissive portion) 118 is provided on the inner surface of the other 112 of the glass substrates 111 and 112. The counter electrode 120 is provided on the transparent stepped layer 119 so as to be common to all the pixels 20_{C}.

In FIG. 10 showing the cross sectional structure of the reflective portion 22, the irregular diffusion surface is formed on the surface of the optical diffusion layer 115. Also, the reflective electrode 117 is provided on the irregular diffusion surface. The transparent stepped layer 119 is provided on the inner surface of the other 112 of the glass substrates 111 and 112 through the color filter (reflective portion) 118. The counter electrode 120 is provided on the color filter 118 so as to be common to all the pixels 20_{C}.

As apparent from a comparison between the structure shown in FIG. 9 and the structure shown in FIG. 10, each of the sub-pixels 20_{R}, 20_{G} and 20_{B} has the transparent stepped layer 119 which is formed in the portion corresponding to the reflective portion 22 through the color filter 118. Also, the pixel structure is obtained such that a portion having the transparent stepped layer 119 existing therein, and a portion not having the transparent stepped layer 119 existing therein are disposed in parallel with the long side direction of each of the sub-pixels 20_{R}, 20_{G} and 20_{B}.

In the semi-transmission type liquid crystal panel 11_{C} according to Example 3 having the structure described above, the phase difference plate 31 and the polarizing plate 32 are provided in this order on the display back surface of the glass substrate 111, that is, on the surface on the backlight 13 side. The phase difference plate 33 and the polarizing plate 34 are provided in this order on the display surface as well of the glass substrate 112.

As also previously stated, in the parallax barrier 12 using the liquid crystal system, when the suitable voltage is applied across the stripe-like electrodes and the counter electrode 120, as shown in FIG. 8B, the stripe-like light blocking portions 124 are formed at the given intervals so as to correspond to the stripe-like electrodes, respectively. Also, the portion between each adjacent two light blocking portions 124, 124 becomes the transmissive portion 125.

FIG. 8B shows the relatively positional relationship between the arrangement of the pixels R for the right eye and the pixels L for the left eye in a certain pixel row, and the light blocking portion (barrier) 124 of the parallax barrier 12. Although the pitch of the parallax barrier 12 is approximately equal to that of the LR combination of the pixels R for the right eye, and the pixel L for the left eye, strictly, for causing the 3D image to be seen in anywhere within the panel between the eyes (the interval between the eyes, for example, is 65 mm), the pitch of the parallax barrier 12 is designed so as to be slightly smaller than that of the LR combination of the pixels 20_{C}. Also, the parallax barrier 12 is provided in such a way that the light blocking portion 124 is located in a portion corresponding to the center of the pixel 20_{C}, and the transmissive portion 125 is located in the portion corresponding to the portion between the pixels 20_{C}, 20_{C}.

As described above, in Example 3, the pixel structure is adopted such that in the pixel 20_{C}, the transmissive portion 21 and the reflective portion 22 are provided in parallel with the long side of each of the sub-pixels 20_{R}, 20_{G} and 20_{B} every the sub-pixels 20_{R}, 20_{G} and 20_{B} (refer to FIG. 8A). That is to say, the transmissive portion 21 and the reflective portion 22 are provided right-left symmetrically with respect to the pixel center within the pixel 20_{C}. Also, the parallax barrier 12 is provided in such a way that the light blocking portion 124 is located in the portion corresponding to the center of the pixel 20_{C}, and the transmissive portion 125 is located in the portion corresponding to the portion between the pixels 20_{C}, 20_{C} (refer to FIG. 8B).

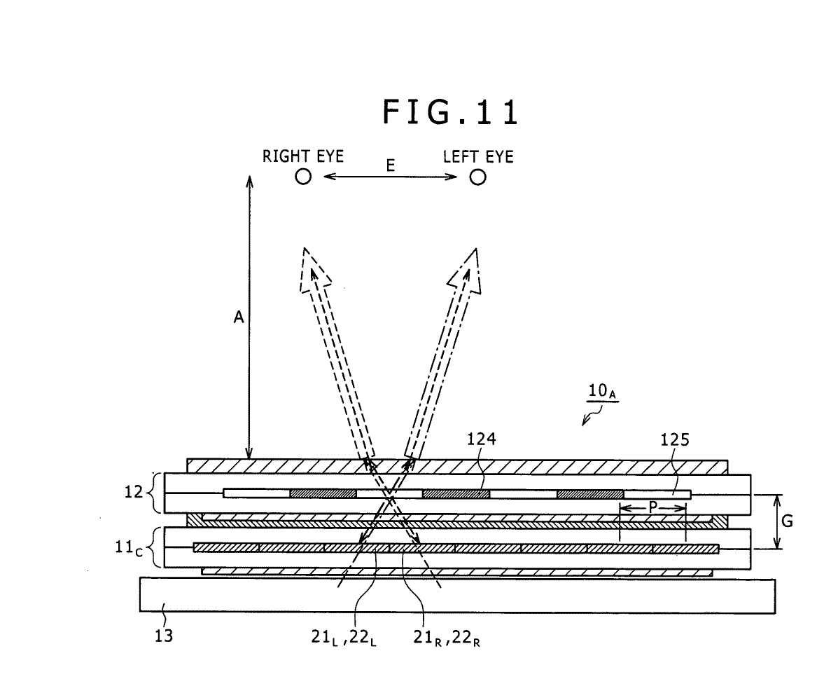

According to the pixel structure, and the relatively positional relationship between the pixel 20_{C} and the light blocking portion 124 of the parallax barrier 12 in such Example 3, as shown in FIG. 11, the transmissive portion 21 and the reflective portion 22 of the pixel 20_{C} are provided right-left symmetrically in the row direction with respect to the positions for the visual recognition made by the observer.

As a result, the luminance information transmitted through the transmissive portion 21_{R} of the pixel R for the right eye, and the luminance information reflected by the reflective portion 22_{R} of the pixel R for the right eye, and the luminance information transmitted through the transmissive portion 21_{L} of the pixel L for the left eye, and the luminance information reflected by the reflective portion 22_{L} of the pixel L for the left eye are equally made incident to both the right eye and left eye of the observer. That is to say, since the luminance information for the right eye, and the luminance information for the left eye which are made incident to the right eye and left eye of the observer, respectively, become equal to each other with respect to the right eye and left eye of the observer, it is possible to suppress the crosstalk. As a result, since the observer can equally sense the luminance information for the right eye, and the luminance information for the left eye by his/her both eyes, it is possible to enhance the visibility of the stereoscopic image.

As can be seen from the above description, in each of Examples 1 to 3, the relationship is obtained such that the stripe direction (longitudinal direction) of the parallax barrier 12 as the optical component, and the stripe direction of the color filter 118 of the semi-transmission type liquid crystal panel 11 (11_{A}, 11_{B}, 11_{C}) bisect at right angles with each other. Also, when in the parallax barrier 12, a set of light blocking portion 124 and transmissive portion 125 is treated as one unit, one unit is provided per two pixels of the semi-transmission type liquid crystal panel 11.

### 1-4. Example 4

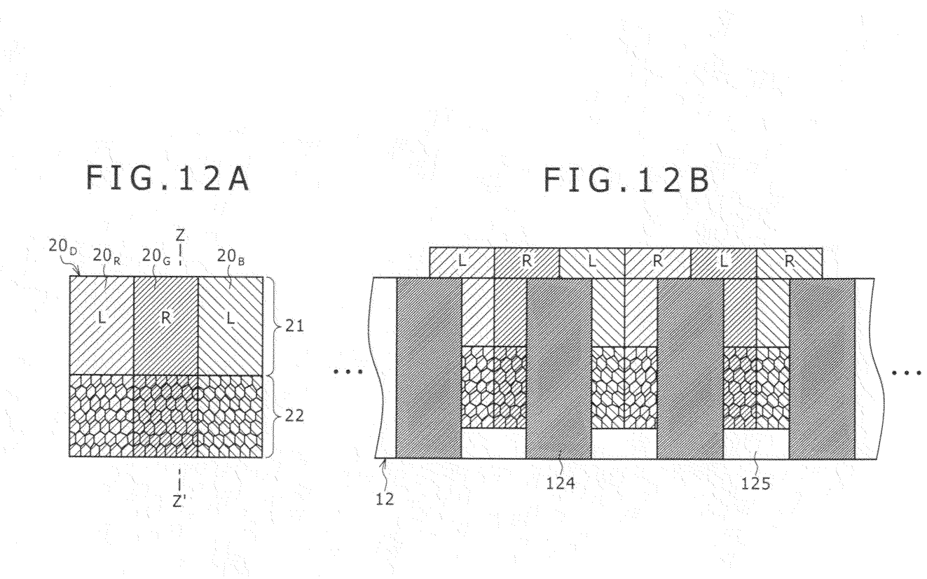

FIGS. 12A and 12B are a view showing a structure of a pixel of a pixel according to Example 4, and a view showing a relatively positional relationship between an arrangement of the pixels R for the right eye, and the pixels L for the left eye, and the light blocking portion of the parallax barrier, respectively, in the case of the color display compliance in the stereoscopic image display device 10_{A} according to the first embodiment of the present disclosure. In FIGS. 12A and 12B, the same portions as those in FIGS. 2A and 2B are designated by the same reference numerals or symbols, respectively.

As shown in FIG. 12A, a pixel 20_{D} according to Example 4 is also composed of, for example, the three sub-pixels 20_{R}, 20_{G} and 20_{B} similarly to the case of the pixel 20_{A} according to Example 1, and, for example, has the rectangular shape. Therefore, each of the three sub-pixels 20_{R}, 20_{G} and 20_{B} has the rectangular shape which is long in the row direction of the matrix-like pixel arrangement.

In each of Examples 1 to 3, the pixel 20 (20_{A}, 20_{B}, 20_{C}) has a layout such that the long side direction of each of the sub-pixels 20_{R}, 20_{G} and 20_{B} becomes the row direction of the matrix-like pixel arrangement. On the other hand, the pixel 20_{D} according to Example 4 has a layout such that the long side direction of each of the sub-pixels 20_{R}, 20_{G} and 20_{B} becomes the column direction of the matrix-like pixel arrangement. That is to say, the pixel 20_{D} according to Example 4 has a structure such that the sub-pixels 20_{R}, 20_{G} and 20_{B} are repeatedly arranged in pixel columns in the row direction.

Also, in the pixel arrangement with the sub-pixels 20_{R}, 20_{G} and 20_{B} as a unit, the pixel columns for the right eye, and the pixel columns for the left eye are alternately arranged with the pixel column of the sub-pixels 20_{R}, 20_{G} and 20_{B} as a unit. That is to say, in each of Examples 1 to 3, the pixel columns for the right eye, and the pixel columns for the left eye are alternately arranged with the pixel column of the pixels 20 each composed of the sub-pixels 20_{R}, 20_{G} and 20_{B} as a unit, whereas in Example 4, the pixel columns for the right eye, and the pixel columns for the left eye are alternately arranged with the pixel column of the sub-pixels 20_{R}, 20_{G} and 20_{B} as a unit. The reflective portion 22, for example, has a smaller area than that of the transmissive portion 21 in each of the sub-pixels 20_{R}, 20_{G} and 20_{B}, and, for example, is provided on the lower side of the pixel 20_{D}, that is, on the lower side of each of the sub-pixels 20_{R}, 20_{G} and 20_{B}.

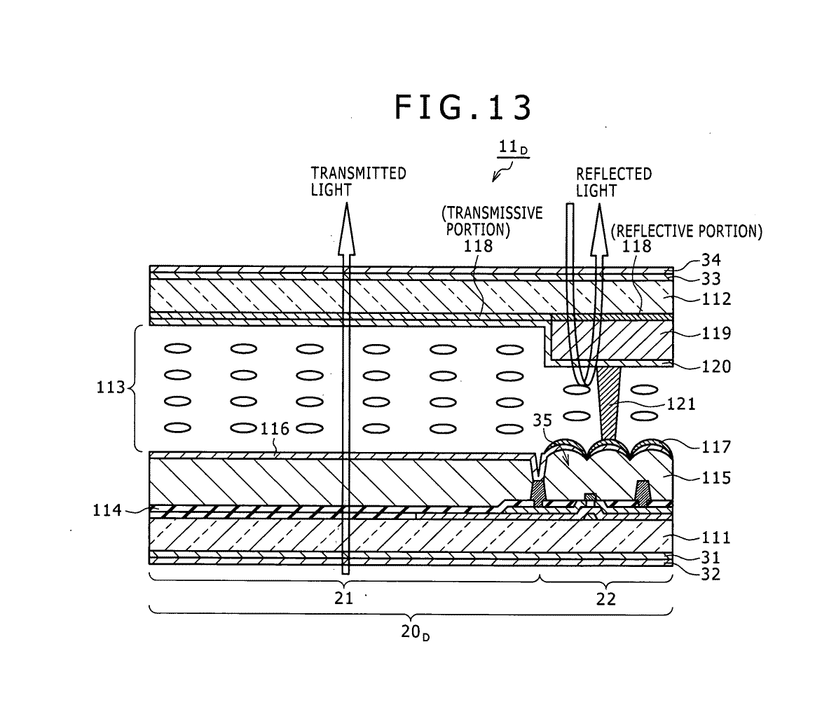

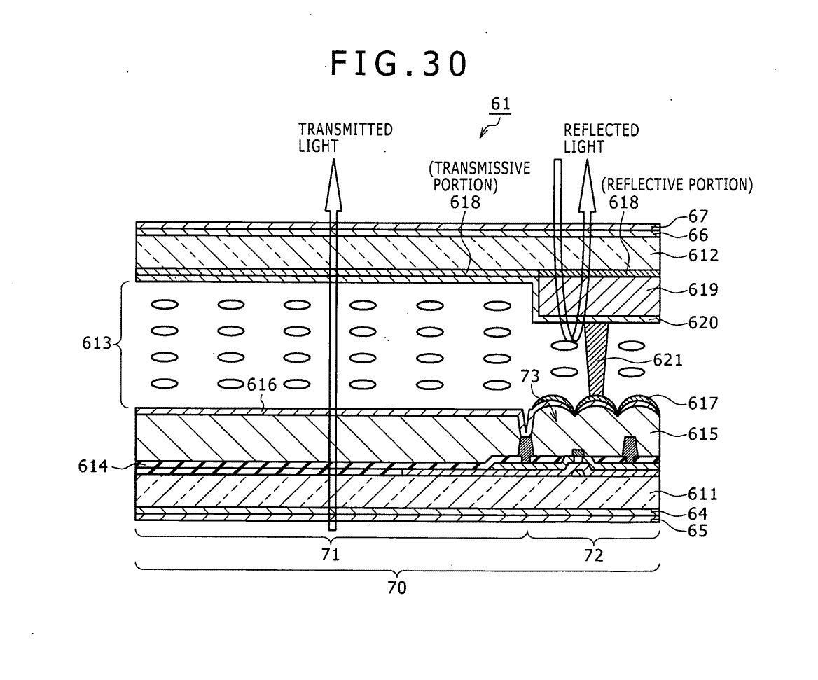

FIG. 13 shows a cross sectional structure of certain one pixel of the semi-transmission type liquid crystal panel 11_{D} according to Example 4. Also, FIG. 13 is a cross sectional view taken on line Z-Z′ of FIG. 12A. As can be seen from a comparison between the structure shown in FIG. 13 and the structure shown in FIG. 30, the structure of the pixel 20_{D} according to Example 4, specifically, the structure of the periphery of the transmissive portion 21 and the reflective portion 22 is basically the same as that in the case of the pixel 70 according to the background art (refer to FIG. 30).

FIG. 12B shows the relatively positional relationship between the arrangement of the pixels R for the right eye and the pixels L for the left eye in a certain pixel row, and the light blocking portion 124 of the parallax barrier 12. As can be seen from FIG. 12B, the light blocking portions 124 of the parallax barrier 12 are formed at the same interval as the pixel pitch in the row direction (in the horizontal direction) of the pixel arrangement with the sub-pixel as a unit. Also, the parallax barrier 12 is provided in such a way that the light blocking portion 124 and the transmissive portion 125 are located among the sub-pixels 20_{R}, 20_{G} and 20_{B}.

As described above, in Example 4, in the pixel arrangement with the sub-pixels 20_{R}, 20_{G} and 20_{B} as a unit, the pixel structure is adopted such that the pixel columns for the right eye, and the pixel columns for the left eye are alternately arranged with the pixel column as a unit (refer to FIG. 12A). Also, the parallax barrier 12 is provided in such a way that the light blocking portion 124 and the transmissive portion 125 are located among the sub-pixels 20_{R}, 20_{G} and 20_{B} (refer to FIG. 12B).

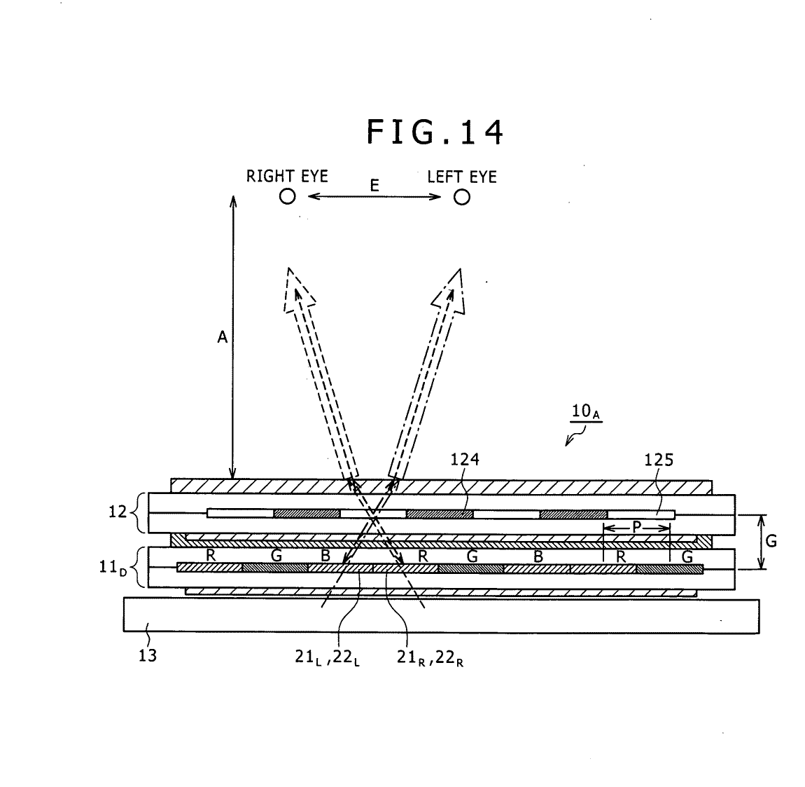

According to the pixel structure, and the relatively positional relationship between the sub-pixels 20_{R}, 20_{G} and 20_{B} and the light blocking portion 124 of the parallax barrier 12 in such Example 4, as shown in FIG. 14, the transmissive portion 21 and the reflective portion 22 of the sub-pixels 20_{R}, 20_{G} and 20_{B} are provided right-left symmetrically in the row direction with respect to the positions for the visual recognition made by the observer.

As a result, the luminance information transmitted through the transmissive portion 21_{R} of the pixel R for the right eye and the luminance information reflected by the reflective portion 22_{R} of the pixel R for the right eye, and the luminance information transmitted through the transmissive portion 21_{L} of the pixel L for the left eye, and the luminance information reflected by the reflective portion 22_{L} of the pixel L for the left eye are equally made incident to both the right eye and left eye of the observer. That is to say, since the luminance information for the right eye, and the luminance information for the left eye which are made incident to the right eye and left eye of the observer, respectively, become equal to each other with respect to the right eye and left eye of the observer, it is possible to suppress the crosstalk. As a result, since the observer can equally sense the luminance information for the right eye, and the luminance information for the left eye by his/her both eyes, it is possible to enhance the visibility of the stereoscopic image.

As can be seen from the above description, in Example 4, the relationship is obtained such that the stripe direction (longitudinal direction) of the parallax barrier 12 as the optical component, and the stripe direction of the color filter 118 of the semi-transmission type liquid crystal panel 11 (11_{D}) is parallel with each other. Also, when in the parallax barrier 12, a set of light blocking portion 124 and transmissive portion 125 is treated as one unit, one unit is provided per two colors of the semi-transmission type liquid crystal panel 11.

It is noted that in each of Examples 1 to 4 described above, the relatively positional relationship between the transmissive portion 21 (21A, 21B) and the reflective portion 22 (22A, 22B) of the pixel 20 (20_{A} to 20_{D}), and the transmissive portion 125 of the parallax barrier 12 is as follows. That is to say, as apparent from FIGS. 2A and 2B, FIGS. 5A and 5B, FIGS. 8A and 8B, and FIGS. 12A and 12B, the transmissive portion 21 (21A, 21B) and the reflective portion 22 (22A, 22B) of the pixel 20 (20_{A} to 20_{D}) are provided line-symmetrically with respect to the center line extending in the long-axis direction of the transmissive portion 125 of the parallax barrier 12.

### 1-5. Example 5

Although each of Examples 1 to 4 is based on a premise of the two parallax (binocular parallax/two viewpoints) system, the first embodiment is by no means limited to the application to the two parallax system, and thus can also be applied to a three or more parallax system, i.e., a multiple parallax system. As an example of the multiple parallax system, a four parallax system will be described below as Example 5 of the first embodiment.

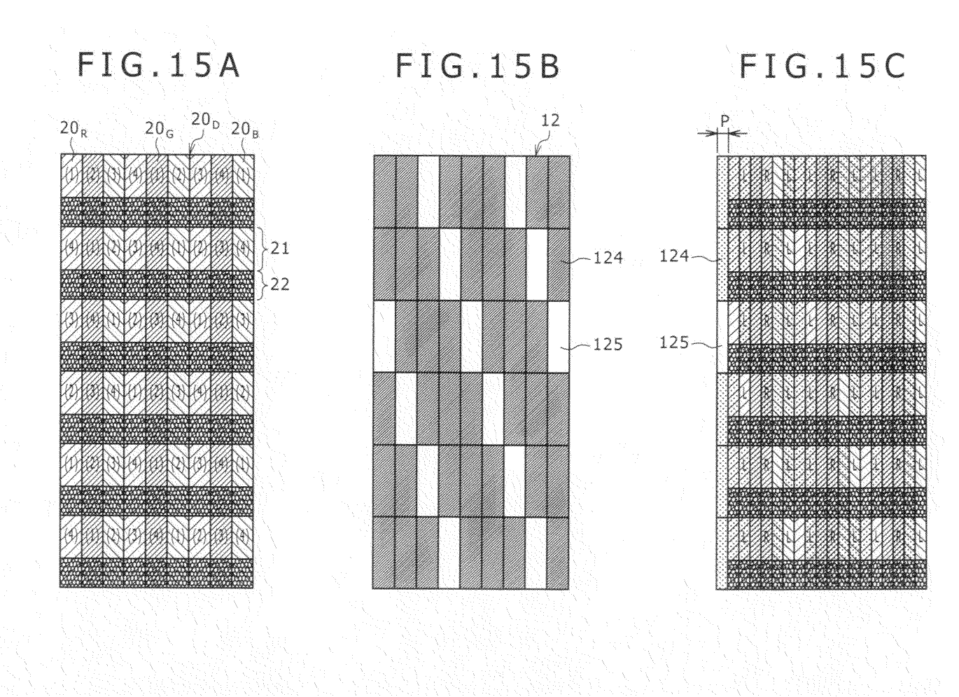

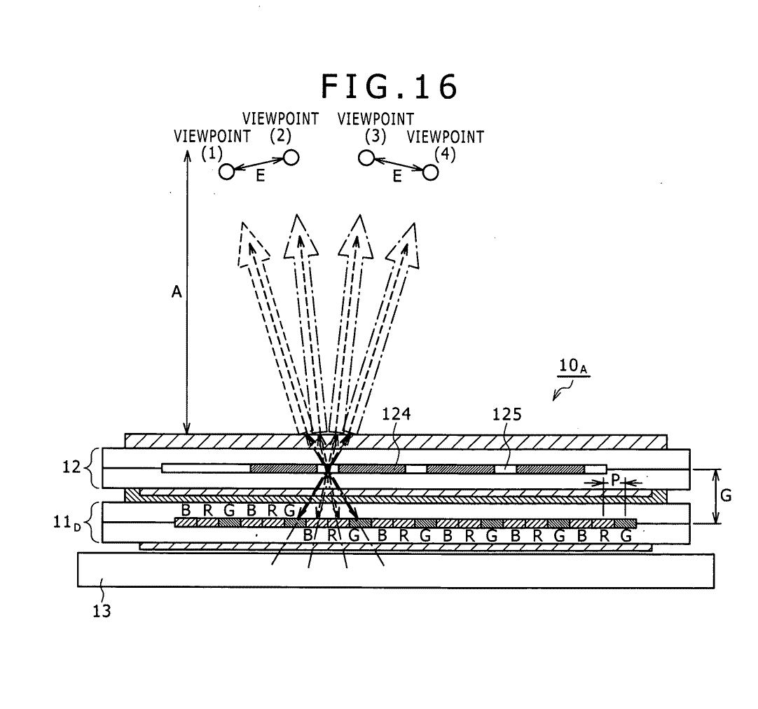

FIGS. 15A, 15B and 15C are a view showing a structure of a pixel according to Example 5, a view showing a structure of the parallax barrier, and a view showing a relatively positional relationship between an arrangement of the sub-pixels R for the right eye, and the sub-pixels L for the left eye, and the light blocking portions of the parallax barrier, respectively, in the case of the color display compliance in the stereoscopic image display device 10_{A} according to the first embodiment. FIG. 16 is a cross sectional view showing a relationship between the transmitted light and the reflected light for the right eye and the left eye in the case of the pixel structure of Example 5.

As shown in FIG. 15A, a pixel structure according to Example 5 is identical to that of the pixel 20_{D} according to Example 4. That is to say, the pixel 20_{D} according to Example 4 has a layout such that the long side direction of each of the sub-pixels 20_{R}, 20_{G} and 20_{B} becomes the column direction of the matrix-like pixel arrangement. More specifically, the pixel 20_{D} according to Example 5 has a structure such that the sub-pixels 20_{R}, 20_{G} and 20_{B} are repeatedly arranged in the row direction.

The structure of the pixel 20_{D} according to Example 5, that is, the sub-pixels 20_{R}, 20_{G} and 20_{B}, specifically, the structure of the periphery of the transmissive portion 21 and the reflective portion 22 is also identical to that of the pixel 20_{D} according to Example 4 shown in FIG. 13. Also, in the pixel arrangement with the sub-pixels 20_{R}, 20_{G} and 20_{B} as a unit, the pixel columns for the right eye, and the pixel columns for the left eye are alternately arranged with the pixel column of the sub-pixels 20_{R}, 20_{G} and 20_{B} as a unit.

For the pixel arrangement with the sub-pixels 20_{R}, 20_{G} and 20_{B} as a unit, in the case of Example 4 using two parallax system, the parallax barrier 12 has the structure such that the longitudinal stripe-like light blocking portion 124 and the transmissive portion 125 are alternately, repeatedly arranged at the pixel pitch.

On the other hand, in the case of Example 5 using the four parallax system, as shown in FIG. 15B, with the adjacent four pixels (sub-pixels) as a unit, the adjacent three pixels of the adjacent four pixels are set as the light blocking portion 124, and the remaining one pixel is set as the transmissive portion 125. Also, there is obtained the structure that the light blocking portion 124 and the transmissive portion 125 for the four pixels as a unit are shifted in order by one pixel every pixel row, that is, the so-called offset structure.

The system using the parallax barrier 12 adopting the offset structure is called a step barrier system. According to the stereoscopic image display device using the step barrier system, a viewing area can be separated with the offset structure of the parallax barrier 12, thereby dispersing the reduction of the resolution. Therefore, there is an advantage that the resolution in the horizontal direction can be enhanced as compared with the case of the two parallax system.

Also, when in the stereoscopic image display device using the step barrier system, the parallax barrier 12 shown in FIG. 15B having the offset structure is made to overlap the pixel structure, shown in FIG. 15A, that the pixel columns for the right eye, and the pixel columns for the left eye are alternately arranged with the sub-pixels having the pixel structure according to Example 5 (that is, Example 4) as a unit, as shown in FIG. 15C, the parallax barrier 12 shown in FIG. 15B is made to overlap the pixel structure shown in FIG. 15A in a state in which the shifting is made in the row direction only by ½ of the pixel pitch P of the sub-pixels. It is noted that for the purpose of clearing up the mutual positional relationship when the parallax barrier 12 shown in FIG. 15B is made to overlap the pixel structure shown in FIG. 15A, in FIG. 15C, the light blocking portion 124 of the parallax barrier 12 is illustrated with rough hatching.

According to the structure of Example 5, similarly to the case of each of Examples 1 to 4, the transmissive portion 21 and the reflective portion 22 of each of the sub-pixels 20_{R}, 20_{G} and 20_{B} are provided right-left symmetrically in the row direction with respect to the positions for the visual recognition made by the observer. That is to say, the transmissive portion 21 and the reflective portion 22 are provided right-left symmetrically in the pixel 20_{D} with respect to the pixel center. As a result, as shown in FIG. 16, when the position of the head is disposed in such a way that the right eye and the left eye are located in a viewpoint (1) and a viewpoint (2), respectively, the following operation and effects can be obtained.

That is to say, the luminance information transmitted through the transmissive portion 21_{R} of the pixel R for the right eye and the luminance information reflected by the reflective portions 22_{R} of the pixel R for the right eye, and the luminance information transmitted through the transmissive portion 21_{L} of the pixel L for the left eye and the luminance information reflected by the reflective portions 22_{L} of the pixel L for the left eye are equally made incident to both the right eye and left eye of the observer. That is to say, since the luminance information for the right eye, and the luminance information for the left eye which are made incident to the right eye and left eye of the observer, respectively, become equal to each other with respect to the right eye and left eye of the observer, it is possible to suppress the crosstalk. As a result, since the observer can equally sense the luminance information for the right eye, and the luminance information for the left eye by his/her both eyes, it is possible to enhance the visibility of the stereoscopic image.

It is noted that in the first embodiment, the parallax barrier 12 using the liquid crystal system is used as the optical component for allowing the plural parallax images displayed on the display panel to be stereoscopically sensed, thereby making it possible to select between the display of the three-dimensional image, and the display of the two-dimensional image. However, the present disclosure is by no means limited to the structure using the parallax barrier 12 adopting the liquid crystal system. That is to say, in the case of the application only for the display of the three-dimensional image, it is also possible to adopt the structure such that the parallax barrier fixedly having the light blocking portion (barrier) 124 is used.

### 2. Second Embodiment

### Lenticular Lens System

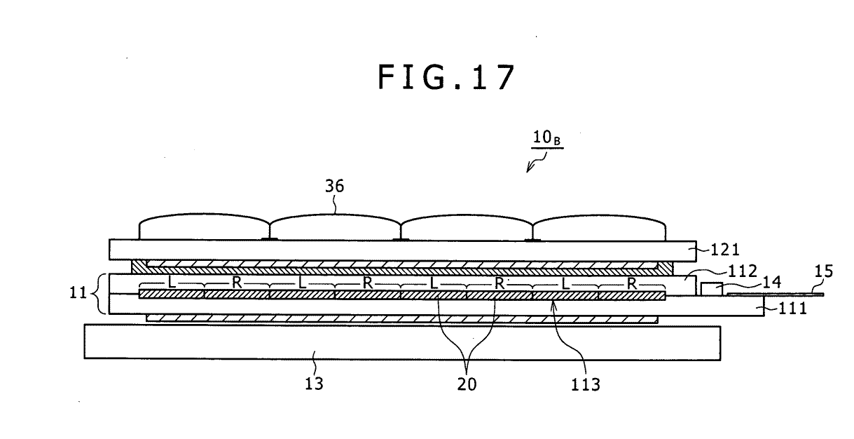

FIG. 17 is a cross sectional view showing an outline of a structure of a stereoscopic image display device according to a second embodiment. In FIG. 17, the same portions as those in FIG. 1 are designated by the same reference numerals or symbols, respectively. The stereoscopic image display device 10_{B} according to the second embodiment is a stereoscopic image display device, adopting a lenticular lens system, which uses a lenticular lens as an optical component for allowing the plural parallax images displayed on the display panel to be stereoscopically sensed.

As shown in FIG. 17, the stereoscopic image display device 10_{B} according to the second embodiment, for example, uses the semi-transmission type liquid crystal panel 11 as the semi-transmission type display portion. Also, the stereoscopic image display device 10_{B} is structured so as to have a lenticular lens 36 and the backlight 13. In this case, the lenticular lens 36 is disposed on the front surface (on the observer side) of the semi-transmission type liquid crystal panel 11. Also, the backlight 13 is disposed on the back surface of the semi-transmission type liquid crystal panel 11.

The semi-transmission type liquid crystal panel 11 has two sheets of transparent substrates, for example, the glass substrates 111 and 112, and the liquid crystal layer 113 which is sealed in the air-tight space defined between these glass substrates 111 and 112. Similarly to the case of the first embodiment, the pixel electrodes and the counter electrode are formed on the inner surfaces of the glass substrates 111 and 112, respectively, so as to sandwich the liquid crystal layer 113 between them. The counter electrode is formed so as to be common to all the pixels. On the other hand, the pixel electrodes are formed in pixels 20. Also, for the purpose of realizing the display of the stereoscopic image, the pixels R for the right eye, and the pixels L for the left eye are alternately disposed so as to form the image for the right eye, and the image for the left eye.

The semiconductor chip 14 in which the driving portion for driving the liquid crystal panel 11 is integrated is mounted on the glass substrate 111 of the glass substrates 111 and 112 by, for example, utilizing the COG technique. The semiconductor chip 14 is electrically connected to the control system provided outside the glass substrate 111 through the flexible printed circuits substrate 15.

The lenticular lens 36 is a transparent lens in which semi-cylindrical stripe-like convex lenses are arranged at a given pitch. Also, the lenticular lens 36 has a property such that the right and left eyes are made to see different images, thereby generating the binocular parallax, and a property such that the viewing range is limited. Therefore, a pitch (pixel pitch) of the pixel columns in the semi-transmission type liquid crystal panel 11, and a lens pitch of the lenticular lens 36 are made to correspond to each other. Also, the longitudinal image for the right eye, and the longitudinal image for the left eye are displayed with the pixel column in the semi-transmission type liquid crystal panel 11 as a unit, thereby making it possible to realize the three-dimensional image.

However, in the case of the lenticular lens 36, the three-dimensional image is displayed in affixed fashion. For allowing the display of the three-dimensional image, and the display of the two-dimensional image to be switched over to each other similarly to the case of the parallax barrier 12 adopting the liquid crystal system, there is expected a technique using a liquid crystal lens for allowing the same function as that of the lenticular lens to be selectively created by, for example, using the liquid crystal. This technique will be described later as Example 2 of the second embodiment.

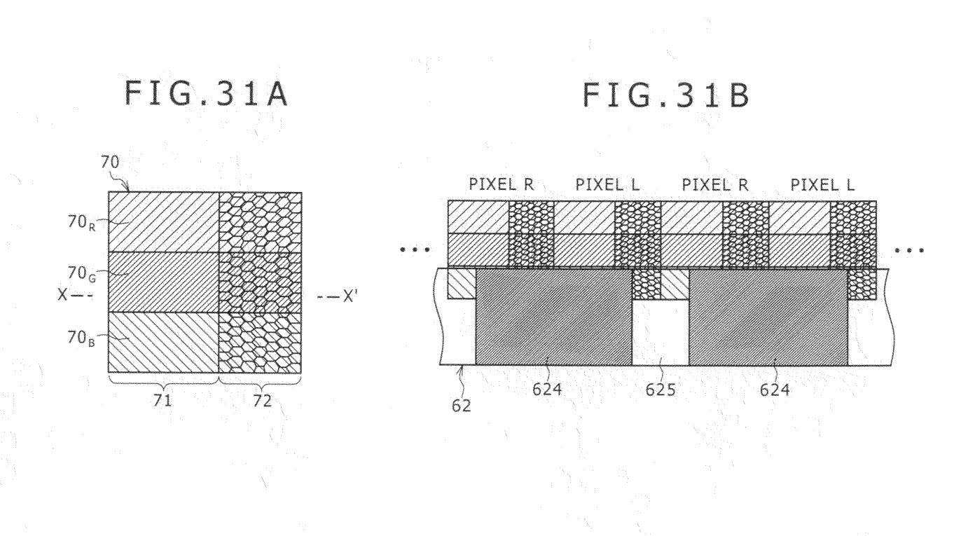

In addition, a liquid crystal lens or a liquid lens as described in Japanese Patent Laid-Open No. 2010-9584 can also be used instead of using the lenticular lens 36 as a fixed lens. In this case, the liquid crystal lens is shown in FIG. 9 or the like of Japanese Patent Laid-Open No. 2010-9584, and the liquid lens is shown in FIG. 31 or the like of Japanese Patent Laid-Open No. 2010-9584.

In the stereoscopic image display device 10_{B} using the lenticular lens system and having the structure described above, each of the pixels (sub-pixels) 20 in the liquid crystal panel 11 has the transmissive portion and the reflective portion. In this case, the transmissive portion carries out the display by using the illuminated light from the backlight 13. Also, the reflective portion carries out the display by reflecting the outside light. Also, in the second embodiment as well of the other embodiments, similarly to the case of the first embodiment, the structure is adopted such that the transmissive portion and the reflective portion of each of the pixels 20 are provided symmetrically in the row direction with respect to the positions for the visual recognition made by the observer, that is, right-left symmetrically with respect to the pixel center.

The transmissive portion and the reflective portion of each of the pixels 20 are provided right-left symmetrically with respect to the positions for the visual recognition made by the observer. As a result, the luminance information transmitted through the transmissive portion of the pixel R for the right eye and the luminance information reflected by the reflective portion of the pixel R for the right eye, and the luminance information transmitted through the transmissive portion of the pixel L for the left eye and the luminance information reflected by the reflective portion of the pixel L for the left eye are equally made incident to both the right eye and left eye of the observer. That is to say, the luminance information for the right eye, and the luminance information for the left eye which are made incident to the right eye and left eye of the observer, respectively, become equal to each other with respect to the right eye and left eye of the observer. As a result, since the observer can equally sense the luminance information for the right eye, and the luminance information for the left eye by his/her both eyes, it is possible to enhance the visibility of the stereoscopic image.

In addition, in the case of the stereoscopic image display device 10_{B} using the lenticular lens system, the light blocking portion does not exist in the lenticular lens 36. Therefore, the light display can be realized as compared with the case of the stereoscopic image display device 10_{A} using the parallax barrier system.

With regard to concrete Examples in each of which the transmissive portion and the reflective portion of each of the pixels 20 are provided right-left symmetrically with respect to the positions for the visual recognition made by the observer (viewer), Examples are expected which are basically the same as Examples 1 to 4 of the first embodiment.

By the way, when the stereoscopic image display device is structured so as to be composed of the lens, part of the pixel is seen at each of the viewpoints through the lens. When a focal point of the lens is approximately focused on the pixel, approximate one point (actually, a line because of the lenticular lens) of the pixel is seen. For this reason, when the pixel structure in the display panel is the structure as shown in FIG. 3 or FIG. 6, 3D lights from the lens appear either as approximately only the transmitted light or as approximately only the reflected light depending on the positions. As a result, the visibility becomes insufficient in terms of the stereoscopic image display device using the semi-transmission type liquid crystal panel.

On the other hand, in the semi-transmission type structure, shown in FIG. 9 or FIG. 10, as shown in Example 3 of the first embodiment, even when the focal point is obtained in any point (actually, the line because of the lenticular lens) through the lens, the reflective portion and the transmissive portion are locked through the lens. Therefore, the display performance of the sufficient three-dimensional image is obtained in terms of the stereoscopic image display device using the semi-transmission type liquid crystal panel.

Hereinafter, Example 1 of the second embodiment corresponding to Example 1 of the first embodiment will be described on behalf of Examples of the second embodiment.

### 2-1. Example 1

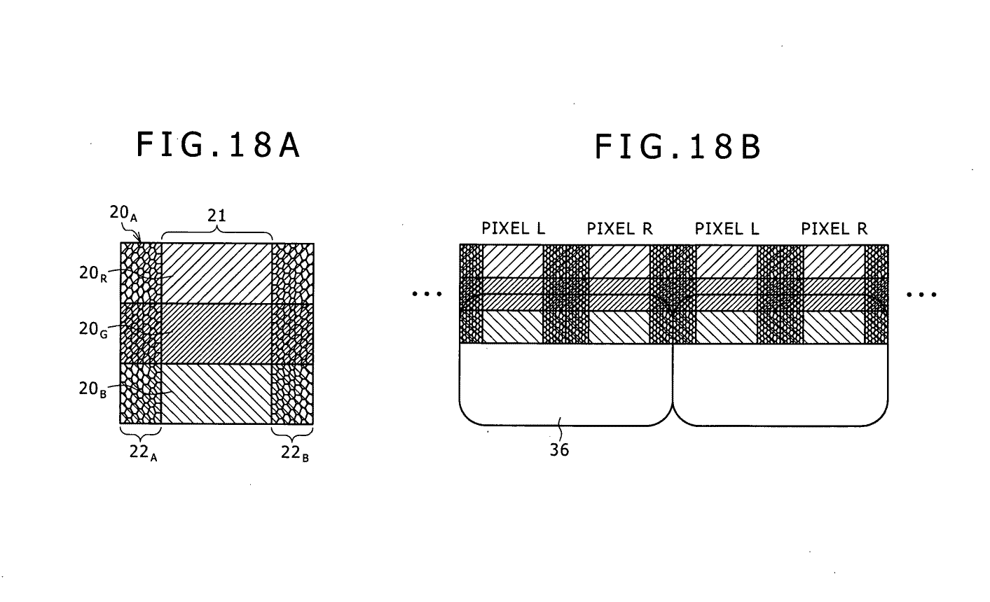

FIGS. 18A and 18B are a view showing a structure of a pixel according to Example 1, and a view showing a relatively positional relationship between an arrangement of the pixels R for the right eye, and the pixels L for the left eye, and a lenticular lens, respectively, in the case of the color display compliance in the stereoscopic image display device 10_{B} according to the second embodiment.

The pixel 20_{A}, according to Example 1, as the minimum unit composing the screen is identical to the pixel 20_{A} according to Example 1 of the first embodiment. That is to say, as shown in FIG. 18A, the pixel 20_{A} according to Example 1, for example, is composed of the sub-pixels 20_{R}, 20_{G} and 20_{B} corresponding to the three primary colors of R, G and B, respectively. The pixel 20_{A} according to Example 1, for example, has the rectangular shape. Therefore, each of the three sub-pixels 20_{R}, 20_{G} and 20_{B} has the rectangular shape which is long in the row direction of the matrix-like pixel arrangement.

Also, the pixel 20_{A} according to Example 1 has the transmissive portion 21, and the reflective portions 22_{A} and 22_{B} every the sub-pixels 20_{R}, 20_{G} and 20_{B}. In this case, the transmissive portion 21 carries out the display by using the illuminated light from the backlight 13. Also, the reflective portions 22_{A} and 22_{B} carry out the display by reflecting the outside light. In the pixel 20_{A} having the rectangular shape, the reflective portions 22_{A} and 22_{B}, for example, have a smaller area than that of the transmissive portion 21 in terms of the total area. Also, the reflective portions 22_{A} and 22_{B} are formed right-left symmetrically along two sides of the rectangle so as to sandwich the transmissive portion 21 between them.

FIG. 18B shows the relatively positional relationship between the arrangement of the pixels R for the right eye, and the pixels R for the left eye, and the lenticular lens 36 in a certain pixel row. As can be seen from FIG. 18B, the lenticular lens 36 is provided in such a way that each of the semi-cylindrical stripe-like convex lenses corresponds to two pixel columns of the pixel column of the pixels R for the right eye, and the pixel column of the pixels L for the left eye which are adjacent to each other with the two pixel columns as a unit (in the case of the two parallax system).

As described above, in Example 1, the pixel structure is adopted such that in the pixel 20_{A}, the transmissive portion 21 is provided at the central portion in a direction orthogonal to the arrangement direction of the sub-pixels 20_{R}, 20_{G} and 20_{B}, that is, in the row direction, and the reflective portions 22_{A} and 22_{B} are provided right-left symmetrically on the both sides of the transmissive portion 21 so as to sandwich the transmissive portion 21 between them (refer to FIG. 18A). That is to say, the transmissive portion 21, and the reflective portions 22_{A} and 22_{B} are provided right-left symmetrically with respect to the pixel center within the pixel 20_{A}. Also, the lenticular lens 36 is provided in such a way that one stripe-like convex lens corresponds to the right and left two pixel columns adjacent to each other with the right and left two pixel columns adjacent to each other as a unit (refer to FIG. 18B).

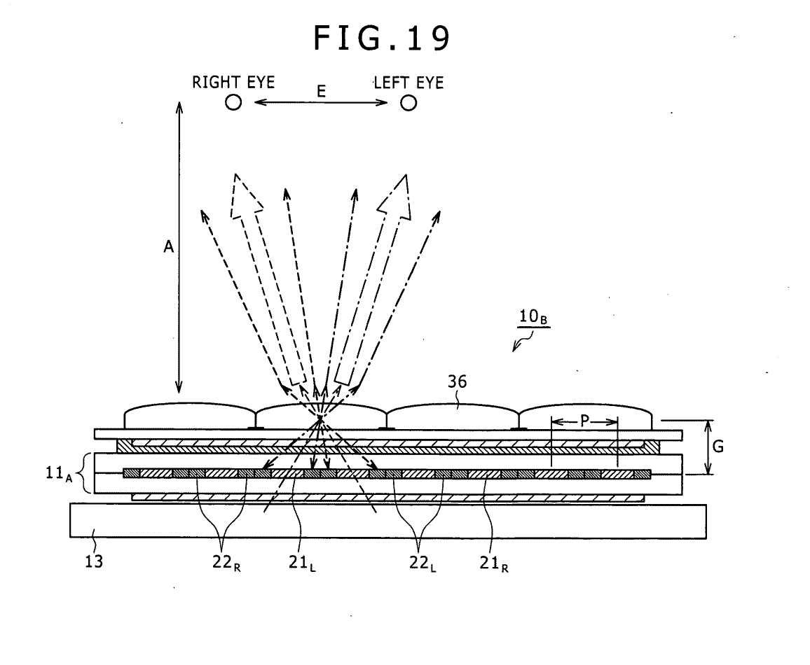

According to the pixel structure, and the relatively positional relationship between the pixel 20_{A} and the individual convex lenses of the lenticular lens 36 in such Example 1, as shown in FIG. 19, the transmissive portion 21, and the reflective portions 22_{A} and 22_{B} of the pixel 20_{A} are provided right-left symmetrically in the row direction with respect to the positions for the visual recognition made by the observer.

As a result, the luminance information transmitted through the transmissive portion 21_{R} of the pixel R for the right eye and the luminance information reflected by the reflective portions 22_{R} (22_{A} and 22_{B}) of the pixel R for the right eye, and the luminance information transmitted through the transmissive portion 21_{L} of the pixel L for the left eye and the luminance information reflected by the reflective portions 22_{L} (22_{A} and 22_{B}) of the pixel L for the left eye are equally made incident to both the right eye and left eye of the observer. That is to say, since the luminance information for the right eye, and the luminance information for the left eye which are made incident to the right eye and left eye of the observer, respectively, become equal to each other with respect to the right eye and left eye of the observer, it is possible to suppress the crosstalk. As a result, since the observer can equally sense the luminance information for the right eye, and the luminance information for the left eye by his/her both eyes, it is possible to enhance the visibility of the stereoscopic image.

In the stereoscopic image display device 10_{B} according to the second embodiment, the distance A suitable for the viewing is approximately given by

Expression (2):

A=(E·G/n)/P (2)

where G is a gap between the centers of the semi-transmission liquid crystal panel 11 and the lenticular lens 36 in a thickness direction, P is a pitch between the pixels, and n is a refractive index of the glass substrate.

In the case, Example 1 of the second embodiment corresponding to Example 1 of the first embodiment has been described on behalf of Examples of the second embodiment. However, Examples 2 to 4 of the second embodiment corresponding to Examples 2 to 4 of the first embodiment, respectively, are basically identical to those of the first embodiment.

In addition, a relationship between the stripe direction (longitudinal direction) of the lenticular lens 36 as the optical component, and the stripe direction of the color filter 118 of the semi-transmission type liquid crystal panel 11, and a relationship between one unit and the pixels are basically identical to those in the first embodiment. In the case of the lenticular lens 36, one stripe-like convex lens becomes one unit.

### 2-2. Example 2

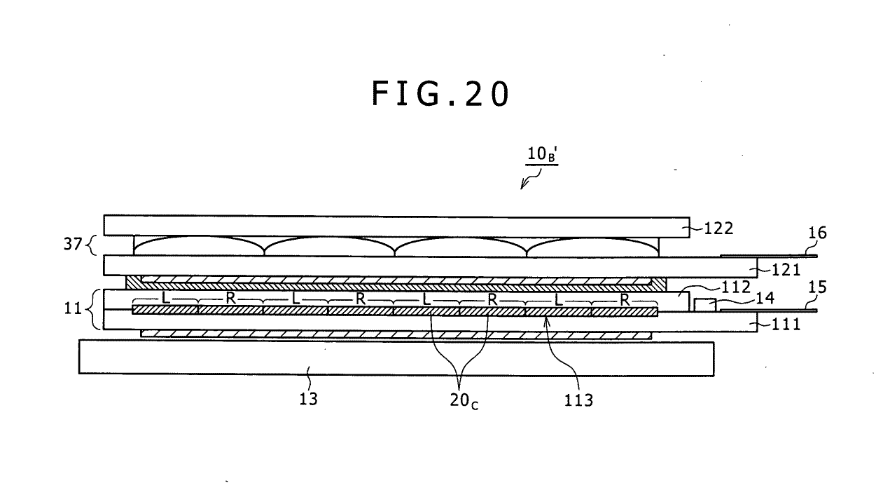

FIG. 20 is a cross sectional view showing an outline of a structure of a stereoscopic image display device according to Example 2 using a liquid crystal lens as an optical component. In FIG. 20, the same portions as those in FIG. 1 are designated by the same reference numerals or symbols, respectively.

The stereoscopic image display device according to Example 2 of the second embodiment is a stereoscopic image display device, adopting the liquid crystal lens system, which uses the liquid crystal lens as the optical component for allowing the plural parallax images displayed on the display panel to be stereoscopically sensed.

In FIG. 20, the stereoscopic image display device 10_{B}′ has basically the same structure as that of the stereoscopic image display device 10_{B} shown in FIG. 17 except that the liquid crystal lens 37 is used instead of using the lenticular lens 36. That is to say, the stereoscopic image display device 10_{B}′ adopting the liquid crystal lens system is structured so as to have the semi-transmission type liquid crystal panel 11, the liquid crystal lens 37 and the backlight 13. In this case, the liquid crystal lens 37 is disposed on the front surface (on the observer side) of the semi-transmission type liquid crystal panel 11. Also, the backlight 13 is disposed on the back surface of the semi-transmission type liquid crystal panel 11.

Here, the liquid crystal lens 37 is such a lens as to generate a lens effect in accordance with a distribution of a refractive index of the liquid crystal itself. Thus, the liquid crystal lens 37 is structured in such a way that a state in which the lens effect is generated, and a state in which no lens effect is generated can be switched over to each other in accordance with a state in which a suitable voltage is applied to the liquid crystal layer, and a state in which no suitable voltage is applied to the liquid crystal layer. That is to say, the stereoscopic image display device 10_{B}′ adopting the liquid crystal lens system can realize the effect of the lenticular lens 36 of Example 1 by using the liquid crystal. In addition, since the liquid crystal is used, the lens effect is not offered when no suitable voltage is applied to the liquid crystal layer. Therefore, in the state in which no suitable voltage is applied to the liquid crystal layer, the display of the three-dimensional image cannot be realized, but the display of the two-dimensional image can be realized.

In addition, with regard to the similar method, it is possible to apply a state in which the lenticular lens and the liquid crystal layer are combined with each other. In this system as well, the display of the two-dimensional image, and the display of the three-dimensional image can be switched over to each other depending on the voltage applied to the liquid crystal layer.

The stripe-like electrodes are formed at given intervals along the column direction (in the vertical direction) of the pixel arrangement in the semi-transmission type liquid crystal panel 11 on one of the glass substrates 121 and 122 between which the liquid crystal lens 37 is sandwiched. Also, the counter electrode is formed throughout the entire surface of the other of the glass substrates 121 and 122. In addition, the flexible printed circuits substrate 16 for taking in the suitable voltage which is intended to be applied across the stripe-like electrodes and the counter electrode from the outside is provided on the glass substrate 121 of the liquid crystal lens 37.

In the liquid crystal lens 37, by applying a suitable voltage across the stripe-like electrodes and the counter electrode, since the liquid crystal rises in portion having the electrode existing therein, and the horizontal alignment of the liquid crystal is held in portion not having the electrode existing therein, the distribution of the refractive index is generated and thus the lens is realized. Also, since the optical component for allowing the plural parallax images displayed on the display panel to be stereoscopically sensed is the lens similarly to the case of Example 1, the light display can be realized as compared with the case of the parallax barrier system.

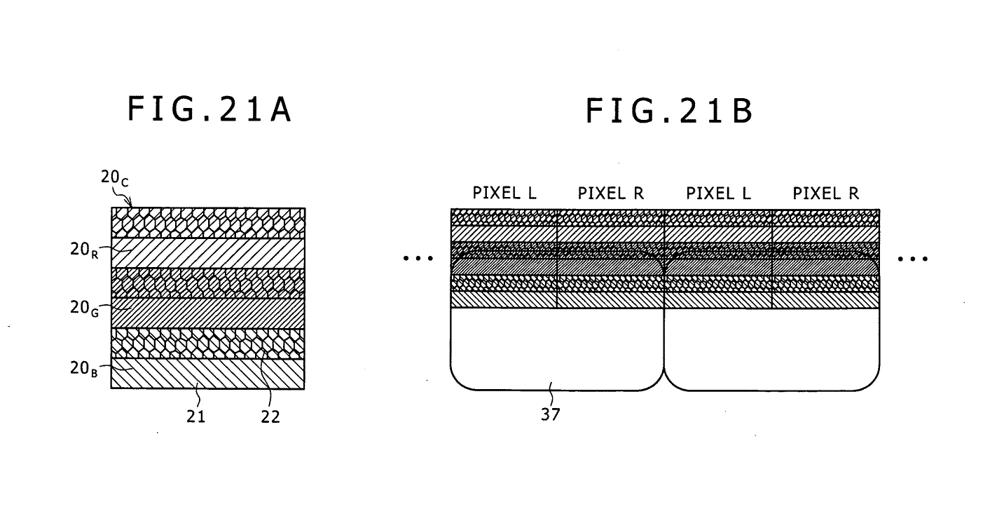

FIGS. 21A and 21B are a view showing a structure of a pixel of a pixel according to Example 2, and a view showing a relatively positional relationship between an arrangement of the pixels R for the right eye, and the pixels L for the left eye, and the liquid crystal lens, respectively, in the case of the color display compliance in the stereoscopic image display device 10_{B}′ adopting a liquid crystal lens system. The pixel structure according to Example 2 is identical to that according to Example 3 of the first embodiment (refer to FIGS. 8A and 8B).

That is to say, in the pixel 20_{C} according to Example 2, a transmissive portion 21 and a reflective portion 22 are provided in parallel with each other every the sub-pixels 20_{R}, 20_{G} and 20_{B}. In this case, the transmissive portion 21 carries out the display by using the illuminated light from the backlight 13. Also, the reflective portion 22 carries out the display by reflecting the outside light. Specifically, the transmissive portion 21 and the reflective portion 22 are formed in parallel with each other along a direction orthogonal to the arrangement direction of the sub-pixels 20_{R}, 20_{G} and 20_{B}, that is, along the row direction of the matrix-like pixel arrangement every the sub-pixels 20_{R}, 20_{G} and 20_{B}. That is to say, the transmissive portion 21 and the reflective portion 22 are disposed in parallel with the long side direction of each of the sub-pixels 20_{R}, 20_{G} and 20_{B}.

FIG. 21B shows a relatively positional relationship between the arrangement of the pixels R for the right eye, and the pixels L for the left eye in a certain pixel row, and the liquid crystal lens 37. As can be seen from FIG. 21B, the liquid crystal lens 37 is provided in such a way that each of the semi-cylindrical stripe-like convex lenses corresponds to two pixel columns of the pixel column of the pixels R for the right eye, and the pixel column of the pixels L for the left eye which are adjacent to each other with the two pixel columns as a unit (in the case of the two parallax system).

As described above, in Example 2, the pixel structure is adopted such that in the pixels 20_{C}, the transmissive portion 21 and the reflective portion 22 are provided in parallel with the long side of each of the sub-pixels 20_{R}, 20_{G} and 20_{B} every the sub-pixels 20_{R}, 20_{G} and 20_{B} (refer to FIG. 21A). That is to say, the transmissive portion 21 and the reflective portion 22 are provided right-left symmetrically with respect to the pixel center within the pixel 20_{C}. Also, the liquid crystal lens 37 is provided in such a way that one stripe-like convex lens corresponds to the right and left two pixel columns adjacent to each other with the right and left two pixel columns adjacent to each other as a unit (refer to FIG. 21B).

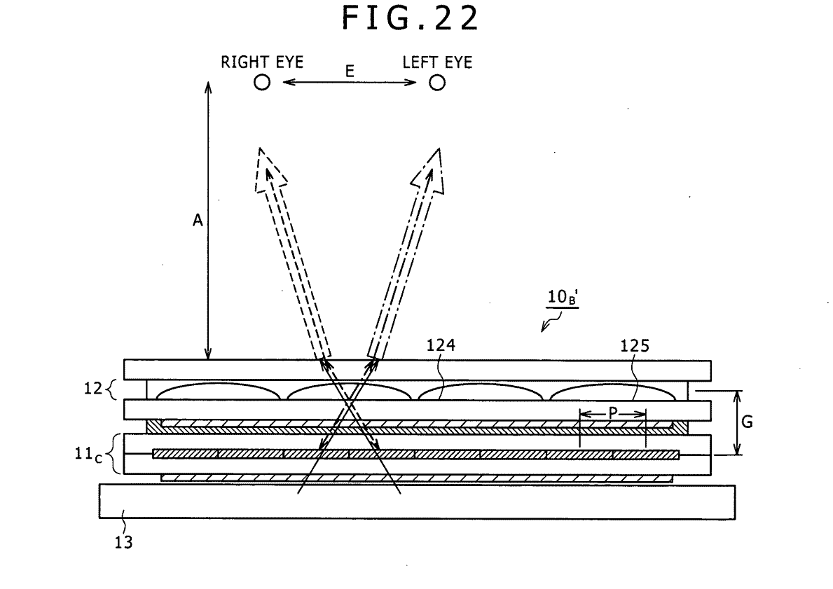

According to the pixel structure, and the relatively positional relationship between the pixel 20_{C} and the individual convex lenses of the liquid crystal lens 37 in such Example 2, as shown in FIG. 22, the transmissive portion 21, and the reflective portions 22_{A} and 22_{B} of the pixel 20_{C} are provided right-left symmetrically in the row direction with respect to the positions for the visual recognition made by the observer. As a result, the luminance information transmitted through the transmissive portion 21_{R} of the pixel R for the right eye and the luminance information reflected by the reflective portions 22_{R} (22_{A} and 22_{B}) of the pixel R for the right eye, and the luminance information transmitted through the transmissive portion 21_{L} of the pixel L for the left eye and the luminance information reflected by the reflective portions 22_{L} (22_{A} and 22_{B}) of the pixel L for the left eye are equally made incident to both the right eye and left eye of the observer.

That is to say, since the luminance information for the right eye, and the luminance information for the left eye which are made incident to the right eye and left eye of the observer, respectively, become equal to each other with respect to the right eye and left eye of the observer, it is possible to suppress the crosstalk. As a result, since the observer can equally sense the luminance information for the right eye, and the luminance information for the left eye by his/her both eyes, it is possible to enhance the visibility of the stereoscopic image. In addition thereto, the liquid crystal lens 37 is used as the optical component for allowing the plural parallax images displayed on the display panel to be stereoscopically sensed, whereby the display of the three-dimensional image, and the display of the two-dimensional image can be selectively realized.

### 3. Changes

Although in each of Examples, the case where one pixel 20 as the minimum unit composing the screen is composed of the three sub-pixels 20_{R}, 20_{G} and 20_{B} corresponding to the three primary colors R, G and B, respectively, one pixel is by no means limited to the combination of the sub-pixels 20_{R}, 20_{G} and 20_{B} corresponding to the three primary colors R, G and B, respectively. Specifically, one pixel can also be structured by further adding one or plural sub-pixels corresponding to one or plural colors to the sub-pixels 20_{R}, 20_{G} and 20_{B} corresponding to the three primary colors R, G and B, respectively. For example, one pixel can also be structured by adding a sub-pixel corresponding to a white color in order to increase the luminance. Or, one pixel can also be structured by adding at least one sub-pixel corresponding to a complementary color in order to enlarge the color reproduction range.

### 4. Third Embodiment

### Electronic Apparatus

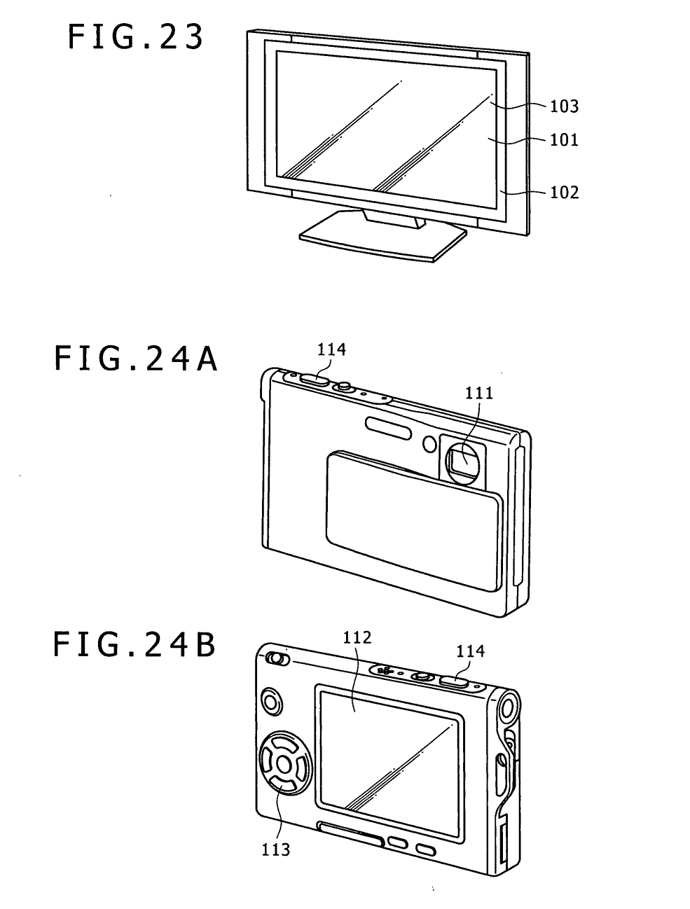

The stereoscopic image display device according to the embodiment described above can be applied to the display devices, of electronic apparatuses in all the fields, in each of which a video signal inputted to the electronic apparatus, or a video signal generated in the electronic apparatus is displayed in the form of an image or a video image. The stereoscopic image display device can be applied to the display devices of various kinds of electronic apparatuses, shown in FIG. 23 to FIGS. 27A to 27G, such as a digital camera, a notebook-size personal computer, mobile terminal equipment such as a mobile phone, and a video camera. In this case, in addition to the digital camera, the notebook-size personal computer, the mobile terminal equipment, and the video camera, a game machine or the like including the display device is contained in the electronic apparatus.

An electronic apparatus according to a third embodiment has the stereoscopic image display device 10_{A} including: the semi-transmission type display panel 11 in which the pixels 20_{A} each having the transmissive portion 21 for transmitting the light made incident from the back surface side, and the reflective portions 22_{A} and 22_{B} for reflecting the light made incident from the front surface side are two-dimensionally disposed in the matrix, and the plural parallax images are adapted to be displayed; and the parallax barrier 12 for causing the observer to stereoscopically sense the plural parallax images displayed by the semi-transmission type display panel 11. In this case, the transmissive portion 21 and the reflective portions 22_{A} and 22_{B} of each of the pixels 20_{A} are provided symmetrically in the row direction with respect to the center of corresponding one of the pixels 20_{A}.

Although in the above description, the electronic apparatus of the third embodiment has the stereoscopic image display device of the first embodiment, it goes without saying that alternatively, the electronic apparatus of the third embodiment can also have the stereoscopic image display device of the second embodiment.

As described above, the stereoscopic image display device according to the present disclosure is used as any of the display devices of the electronic apparatuses in all the fields, thereby making it possible to realize the display of the stereoscopic image which is excellent in visibility. That is to say, as apparent from the descriptions of the embodiments previously stated, with the stereoscopic image display device according to the present disclosure, the luminance information for the right eye, and the luminance information for the left eye can be equally sensed by the corresponding eyes of the observer. Therefore, the visibility of the stereoscopic imager can be enhanced in any of the display devices of the electronic apparatuses in all the fields. In addition, the display of the three-dimensional image, and the display of the two-dimensional image can also be switched over to each other.

### 4-1. Examples of Application

Hereinafter, concrete examples of electronic apparatuses to each of which the stereoscopic image display device 10_{A} according to the embodiment is applied will be described.

FIG. 23 is a perspective view showing a television set, as an example of application, to which the first embodiment is applied. The television set according to the example of application includes an image display screen portion 101 composed of a front panel 102, a filter glass 103, and the like. Also, the television set is manufactured by using the stereoscopic image display device according to the embodiment, as the image display screen portion 101.

FIGS. 24A and 24B are perspective views each showing a digital camera, as another example of application, to which the embodiment is applied, respectively. FIG. 24A is a perspective view when the digital camera is viewed from a front side, and FIG. 24B is a perspective view when the digital camera is viewed from a back side. The digital camera according to another example of application includes a light emitting portion 111 for flash, a display portion 112, a menu switch 113, a shutter button 114, and the like. The digital camera is manufactured by using the stereoscopic image display device according to the embodiment, as the display portion 112.

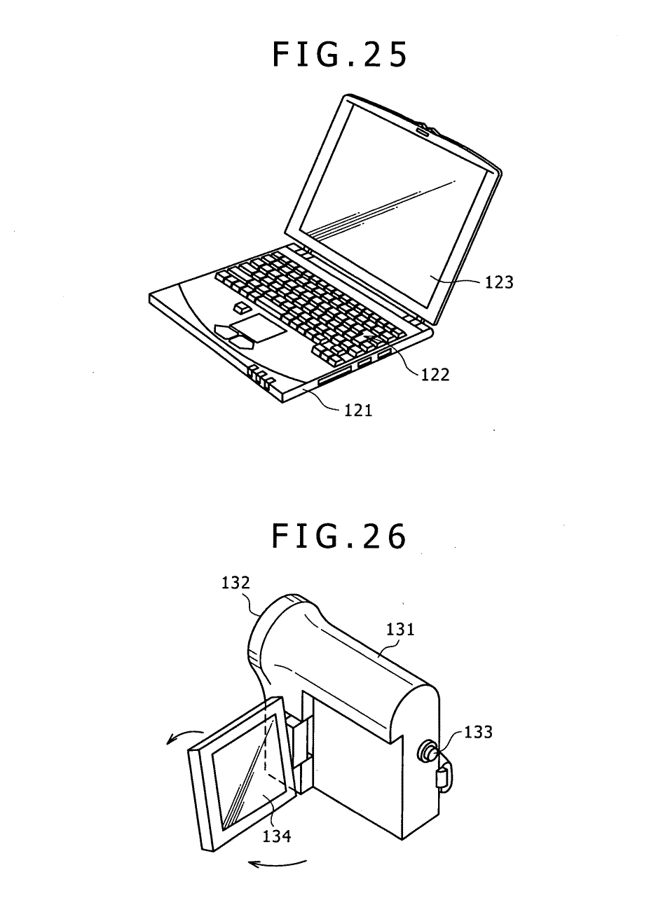

FIG. 25 is a perspective view showing a notebook-size personal computer, as still another example of application, to which the embodiment is applied. The notebook-size personal computer according to the still another example of application includes a main body 121, a keyboard 122 which is manipulated when characters or the like are inputted, a display portion 123 for displaying thereon an image, and the like. The notebook-size personal computer is manufactured by using the stereoscopic image display device according to the embodiment, as the display portion 123.

FIG. 26 is a perspective view showing a video camera, as yet another example of application, to which the embodiment is applied. The video camera according to the yet another example of application includes a main body portion 131, a lens 132 which captures an image of a subject and which is provided on a side surface directed forward, a start/stop switch 133 which is manufactured when an image of a subject is captured, a display portion 134, and the like. The video camera is manufactured by using the stereoscopic image display device according to the embodiment, as the display portion 134.

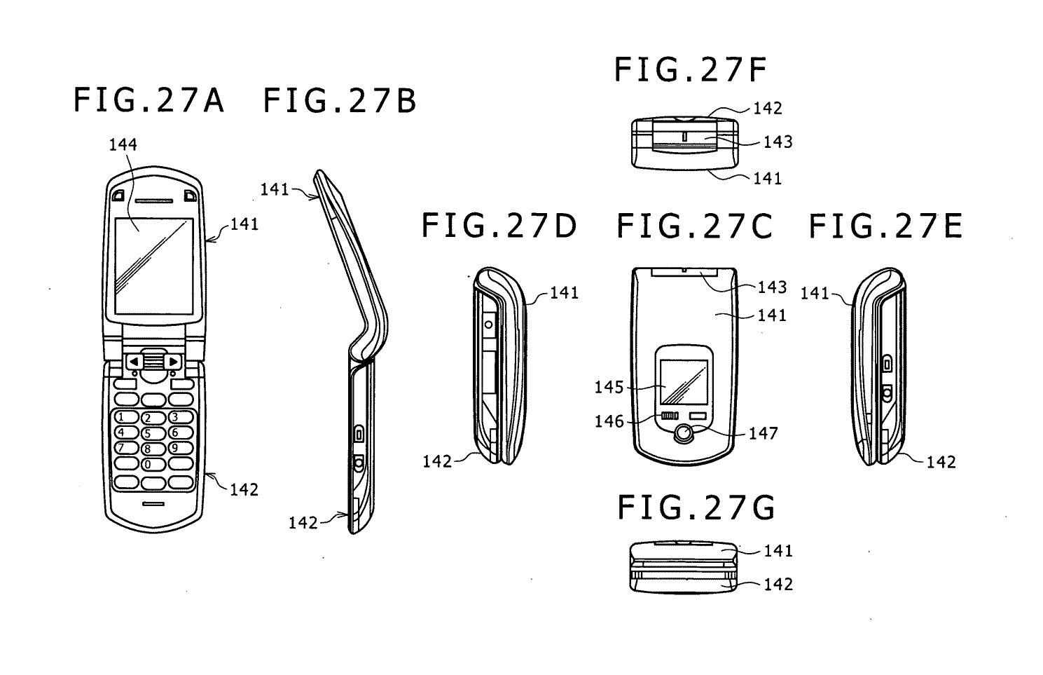

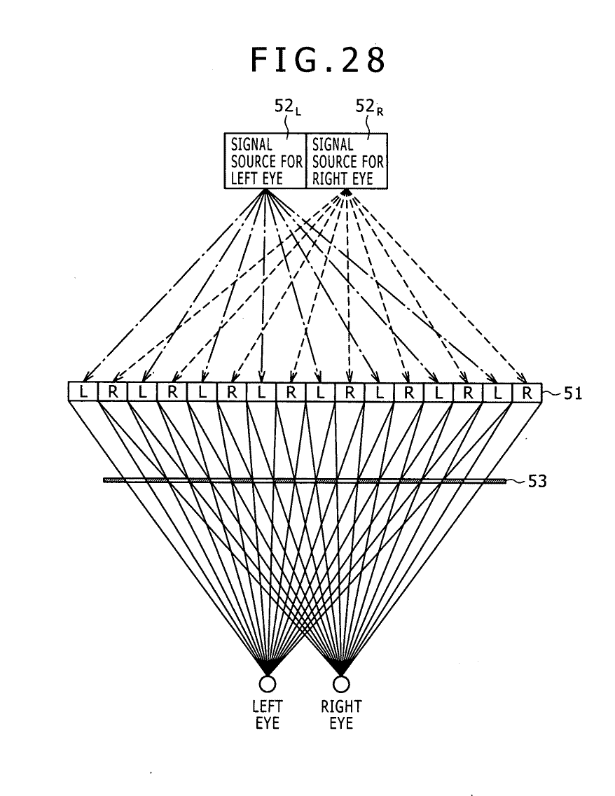

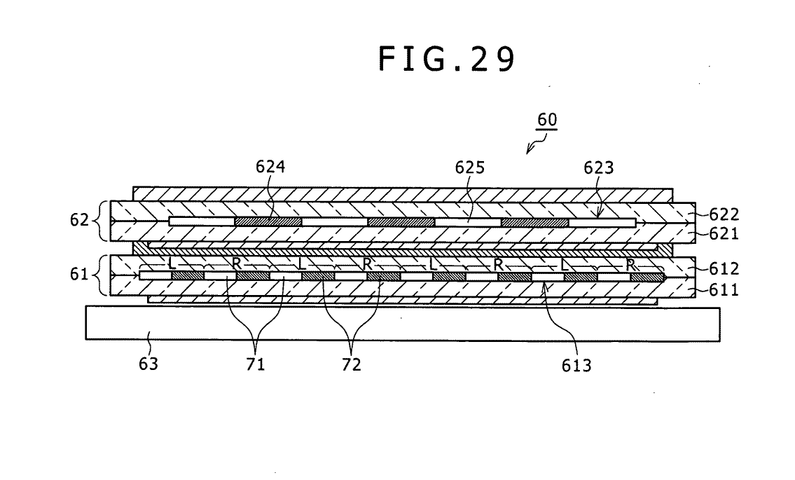

FIGS. 27A to 27G are respectively views showing mobile terminal equipment, for example, a mobile phone, as a further example of application, to which the first embodiment is applied. FIG. 27A is a front view in an open state of the mobile phone, FIG. 27B is a side elevational view in the open state of the mobile phone, FIG. 27C is a front view in a close state of the mobile phone, FIG. 27D is a left side elevational view in the close state of the mobile phone, FIG. 27E is a right side elevational view in the close state of the mobile phone, FIG. 27F is a top plan view in the close state of the mobile phone, and FIG. 27G is a bottom view in the close state of the mobile phone. The mobile phone according to the further example of application includes an upper casing 141, a lower casing 142, a connection portion (a hinge portion in this case) 143, a display portion 144, a sub-display portion 145, a picture light 146, a camera 147, and the like. The mobile phone is manufactured by using the stereoscopic image display device according to the embodiment of the present disclosure either as the display portion 144 or as the sub-display portion 145.

In addition, the above described embodiments may be implemented in method executed by a controller or computer or stored as a process on a computer readable medium that when executed by a computer performs the steps of symmetrically selecting transmission and receiving portions of a pixel, set of pixels, or pixel group to display a parallax image. The computer readable medium may by a read only memory (ROM), random access memory (RAM), graphics processor, central processing unit (CPU), network interface card, etc. Further, the controller is not limited to a computer and may be any other electronic device that has at least a processor.

The present application contains subject matter related to that disclosed in Japanese Priority Patent Application JP 2010-132626 filed in the Japan Patent Office on Jun. 10, 2010, the entire content of which is hereby incorporated by reference.

It should be understood by those skilled in the art that various modifications, combinations, sub-combinations and alterations may occur depending on design requirements and other factor in so far as they are within the scope of the appended claims or the equivalents thereof.

What is claimed is:

1. A parallax system, comprising:
a set of pixels disposed in a matrix,
wherein each pixel of the set of pixels has a transmission portion and a reflective portion, and
the transmission portion and the reflective portion are symmetrically arranged about a pixel center.

2. The parallax system of claim 1, wherein the transmission portion and the reflective portion are symmetrically arranged in a row direction about the pixel center.

3. The parallax system of claim 2, wherein the transmission portion is a set of two transmission portions that symmetrically boarder in the row direction the reflective portion that is centered on the pixel center.

4. The parallax system of claim 2, wherein the reflective portion is a set of two reflective portions that symmetrically boarder in the row direction the transmission portion that is centered on the pixel center.

5. The parallax system of claim 1, wherein the transmission portions and the reflective portions are alternatively arranged in parallel with a row direction of the pixel.

6. The parallax system of claim 1, wherein a total area of the transmission portion is greater than a total area of the reflective portion.

7. The parallax system of claim 1, wherein a backlight provides a luminance source for the transmission portion.

8. The parallax system of claim 1, wherein an outside light provides a luminance source for the reflective portion.

9. The parallax system of claim 1, wherein the parallax system is a parallax barrier system that has a parallax barrier layer disposed on a side opposite a substrate side of the set of pixels disposed in matrix.

10. The parallax system of claim 9, wherein the parallax barrier layer comprises a set of blocking portions, and
each blocking portion of the set of blocking portions corresponds to at least one pixel of the set of pixels.

11. The parallax system of claim 1, wherein the parallax system is a parallax lens system that has a parallax lens layer disposed on a side opposite a substrate side of the set of pixels disposed in matrix.

12. The parallax barrier system of claim 11, wherein the parallax lens layer comprises a set of parallax lenses, and
each parallax lens of the set of parallax lenses corresponds to at least one pixel of the set of pixels.

13. A parallax image panel, comprising:
a pixel layer including a set of pixels disposed in a matrix, wherein each pixel of the set of pixels has a transmission portion and a reflective portion, and
the transmission portion and the reflective portion are symmetrically arranged about a pixel center.

14. A device comprising a parallax image panel, including:
a pixel layer including a set of pixels disposed in a matrix, wherein each pixel of the set of pixels has a transmission portion and a reflective portion,
the transmission portion and the reflective portion are symmetrically arranged about a pixel center, and
the device is one of a digital camera, a personal computer, a mobile terminal equipment, a video camera, or a game machine.

15. A parallax display method, comprising:
disposing a set of pixels in a matrix,
wherein each pixel of the set of pixels has a transmission portion and a reflective portion; and
symmetrically arranging the transmission portion and the reflective portion about a pixel center.

16. A non-transitory computer readable medium storing program code that when executed by a computer performs a parallax display process in a parallax system including a set of pixels disposed in a matrix, wherein each pixel of the set of pixels has a transmission portion and a reflective portion, the process comprising:
symmetrically selecting, by a computer, the transmission portion and the reflective portion about a pixel center.
